(19) United States
(12) Patent Application Publication
(10) Pub. No.: US 2017/0160593 A1
(43) Pub. Date: Jun. 8, 2017

(54) LIQUID CRYSTAL DISPLAY AND METHOD OF MANUFACTURING THE SAME

(71) Applicant: SAMSUNG DISPLAY CO., LTD., Yongin-si (KR)

(72) Inventors: Jae Bum CHO, Seoul (KR); Hyeok Jin LEE, Seongnam-si (KR); Oh Jeong KWON, Hwaseong-si (KR); Ka Eun KIM, Yongin-si (KR); Su Jin KIM, Seoul (KR); Ki Chul SHIN, Seongnam-si (KR)

(21) Appl. No.: 15/182,854

(22) Filed: Jun. 15, 2016

(30) Foreign Application Priority Data
Dec. 3, 2015 (KR) 10-2015-0171383

(51) Int. Cl. G02F 1/1337; C09D 129/12; C09D 133/14; G02F 1/1343; C09D 137/00

(52) U.S. Cl. CPC G02F 1/133711; G02F 1/133788; G02F 1/134309; C09D 137/00; C09D 133/14; C09D 129/12; G02F 2201/121; G02F 2201/56; G02F 2201/123

(57) ABSTRACT

A liquid crystal display (LCD) includes a first substrate which has a first surface, a first alignment layer which is disposed on the first surface of the first substrate and includes a polymerization initiator, a photocurable layer which is formed on the first alignment layer and includes an azobenzene group, a second substrate which has a first surface facing the first substrate and a second surface located opposite the first surface thereof, a second alignment layer which is disposed on the first surface of the second substrate, and a liquid crystal layer which is interposed between the photocurable layer and the second alignment layer.

### CROSS-REFERENCE TO RELATED APPLICATION

Korean Patent Application No. 10-2015-0171383, filed on Dec. 3, 2015, in the Korean Intellectual Property Office, and entitled: “Liquid Crystal Display and Method of Manufacturing the Same,” is incorporated by reference herein in its entirety.

### BACKGROUND

1. Field

Embodiments relate to a liquid crystal display (LCD) and a method of manufacturing the same.

2. Description of the Related Art

Liquid crystal displays (LCDs) are one of the most widely used types of flat panel displays. As LCDs are used as displays of televisions, their screens are becoming larger in size. As the size of the LCDs increases, a viewpoint may greatly differ depending on whether a viewer watches a central part of the screen or a right or left end of the screen.

Generally, an LCD includes a pair of substrates having field generating electrodes, such as pixel electrodes and a common electrode, and a liquid crystal layer interposed between the two substrates. The LCD generates an electric field in the liquid crystal layer by applying voltages to the field generating electrodes. Accordingly, the alignment of liquid crystals of the liquid crystal layer is determined, and polarization of incident light is controlled. As a result, an image is displayed on the LCD.

### SUMMARY

Embodiments are directed to a liquid crystal display (LCD), including a first substrate which has a first surface, a first alignment layer which is disposed on the first surface of the first substrate and includes a polymerization initiator, a photocurable layer which is formed on the first alignment layer and includes an azobenzene group, a second substrate which has a first surface facing the first substrate and a second surface located opposite the first surface thereof, a second alignment layer which is disposed on the first surface of the second substrate, and a liquid crystal layer which is interposed between the photocurable layer and the second alignment layer.

The liquid crystal layer may include first liquid crystal molecules adjacent to the photocurable layer and second liquid crystal molecules adjacent to the second alignment layer. The first liquid crystal molecules may be aligned more vertically than the second liquid crystal molecules in an initial alignment state.

Surface roughness of the first alignment layer may be greater than that of the second alignment layer.

The second alignment layer may not include a polymerization initiator.

The photocurable layer may be formed by polymerization of a photocuring agent which contains a compound represented by Chemical Formula (1):

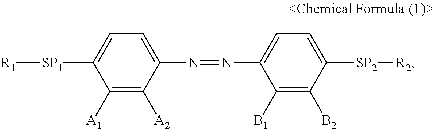

In Chemical Formula (1), each of R₁ and R₂ may independently be a methacrylate group, an acrylate group, a vinyl group, a vinyloxy group, or an epoxy group, each of SP₁ and SP₂ may independently be a single bond, an alkyl group having 1 to 12 carbon atoms, or an alkoxy group having 1 to 12 carbon atoms, each of A₁ and A₂ may independently be hydrogen or a halogen, and each of B₁ and B₂ may independently be hydrogen or a halogen. At least one of A₁ and A₂ may be hydrogen and at least one of B₁ and B₂ may be hydrogen.

The compound represented by Chemical Formula (1) may be a compound represented by any one of Chemical Formulae (2) through (5):

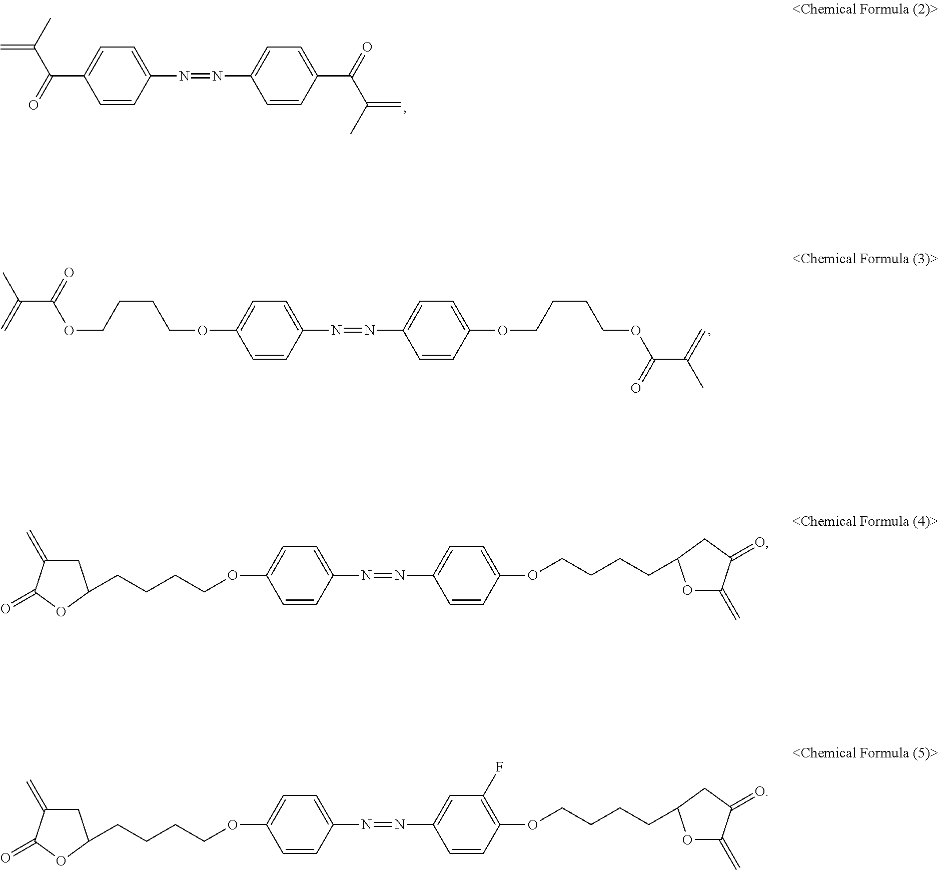 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

The first substrate may include a first base substrate and a pixel electrode which is disposed on the first base substrate and has a domain partition means, and the second substrate may include a second base substrate and a common electrode which is disposed on the second base substrate.

The first substrate and the second substrate may be bent in the same direction. The second surface of the second substrate may be bent concavely.

Embodiments are also directed to a method of manufacturing an LCD, the method including preparing a first substrate having a first alignment layer, which includes a polymerization initiator, formed on a surface thereof, preparing a second substrate having a second alignment layer formed on a surface thereof, providing a liquid crystal layer between the first alignment layer and the second alignment layer, and forming a photocurable layer, which includes an azobenzene group, on a surface of the first alignment layer by irradiating light in a state where an electric field has been applied to the liquid crystal layer.

The preparing of the first substrate having the first alignment layer may include providing a first aligning agent, which includes a polymerization initiator, onto the first substrate and forming the first alignment layer by curing the first aligning agent, the preparing of the second substrate having the second alignment layer may include providing a second aligning agent, which does not include a polymerization initiator, onto the second substrate and forming the second alignment layer by curing the second aligning agent, and the providing of the liquid crystal layer may include providing a liquid crystal layer which includes a photocuring agent having an azobenzene group.

The preparing of the first substrate having the first alignment layer may include providing a photocuring agent which includes an azobenzene group and a first aligning agent which includes a polymerization initiator onto the first substrate, and forming the first alignment layer by curing the first aligning agent, and the preparing of the second substrate having the second alignment layer may include providing a second aligning agent, which does not include a polymerization initiator, onto the second substrate, and forming the second alignment layer by curing the second aligning agent.

The curing of the first aligning agent may include curing the first aligning agent at a temperature of 170 to 250° C.

Ultraviolet (UV) light having a wavelength of 355 to 365 nanometers may be irradiated in the irradiating of the light, and the photocurable layer may be formed by polymerization of a photocuring agent having an azobenzene group.

The photocuring agent may include a compound represented by Chemical Formula (1):

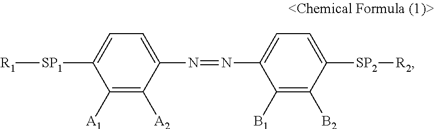

In Chemical Formula (1), each of R₁ and R₂ may independently be a methacrylate group, an acrylate group, a vinyl group, a vinyloxy group, or an epoxy group, each of SP₁ and SP₂ may independently be a single bond, an alkyl group having 1 to 12 carbon atoms, or an alkoxy group having 1 to 12 carbon atoms, each of A₁ and A₂ may independently be hydrogen or a halogen, and each of B₁ and B₂ may independently be hydrogen or a halogen. At least one of A₁ and A₂ may be hydrogen and at least one of B₁ and B₂ may be hydrogen.

The compound represented by Chemical Formula (1) may be a compound represented by any one of Chemical Formulae (2) through (5):

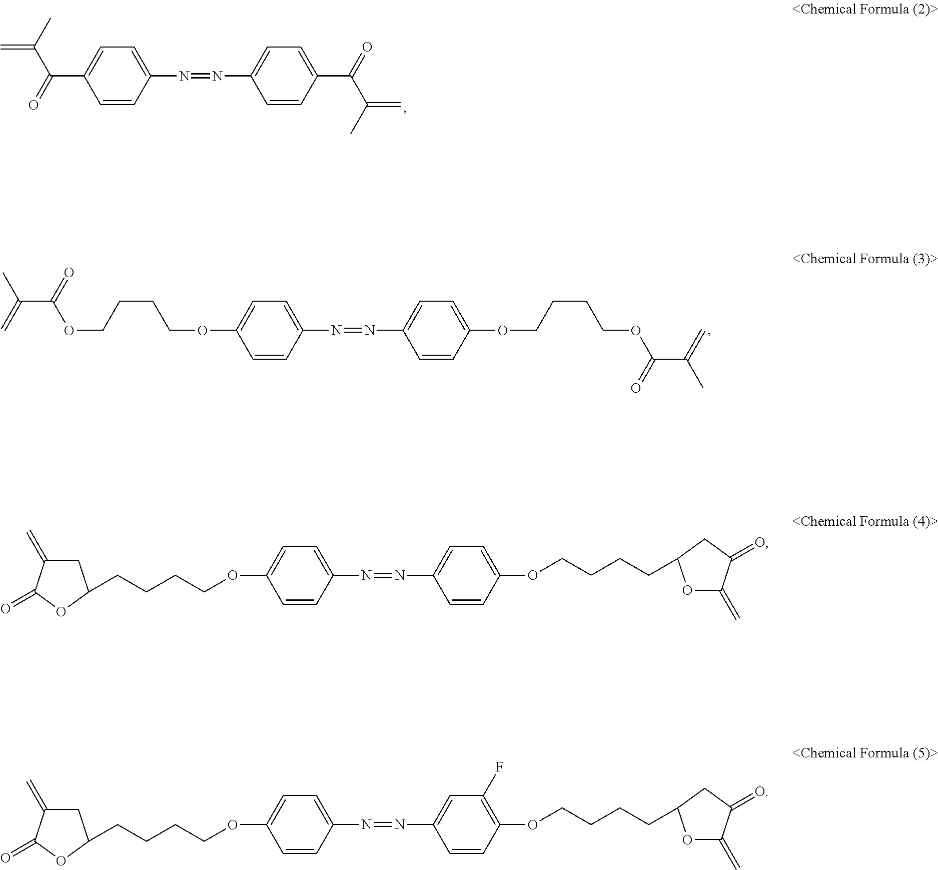 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

The method may further include irradiating light in a state where no electric field has been applied to the liquid crystal layer after the irradiating of the light in the state where the electric field has been applied to the liquid crystal layer.

The liquid crystal layer may include first liquid crystal molecules adjacent to the photocurable layer and second liquid crystal molecules adjacent to the second alignment layer, and the second liquid crystal molecules may be aligned more vertically than the first liquid crystal molecules in the irradiating of the light in the state where no electric field has been applied to the liquid crystal layer.

In the irradiating of the light in the state where no electric field has been applied to the liquid crystal layer, surface roughness of the first alignment layer may be greater than that of the second alignment layer.

The UV light having the wavelength of 355 to 365 nanometers may be irradiated at an exposure dose of 4 J/cm² or less in the irradiating of the UV light having the wavelength of 355 to 365 nanometers, a phase transition temperature of the photocuring agent may be 200° C. or above, and an average pretilt angle of liquid crystal molecules in the liquid crystal layer may be 88.8 degrees or less in the irradiating of the light in the state where no electric field has been applied to the liquid crystal layer.

The UV light may be irradiated for 80 minutes or less in the state where no electric field has been applied to the liquid crystal layer in the irradiating of the light in the state where no electric field has been applied to the liquid crystal layer, and content of the photocuring agent in the liquid crystal layer may be 100 parts per million or less in the irradiating of the light in the state where no electric field has been applied to the liquid crystal layer.

### BRIEF DESCRIPTION OF THE DRAWINGS

Features will become apparent to those of skill in the art by describing in detail example embodiments with reference to the attached drawings in which:

FIG. 1 illustrates a schematic exploded perspective view of an example embodiment of a display device;

FIG. 2 illustrates a schematic layout view of a pixel illustrated in FIG. 1;

FIG. 3 illustrates a cross-sectional view taken along line of FIG. 2;

FIG. 4 illustrates a cross-sectional view taken along line IV-IV′ of FIG. 2;

FIG. 5 illustrates a flowchart illustrating an example process of manufacturing a liquid crystal display (LCD);

FIGS. 6 through 11 illustrate cross-sectional views of stages in a manufacturing process of FIG. 5;

FIG. 12 illustrates a flowchart of another example process of manufacturing an LCD; and

FIGS. 13 through 18 illustrate cross-sectional views of stages in the manufacturing process of FIG. 12.

FIG. 19 illustrates comparison of differential scanning calorimetry curves according to Reference 1.

FIG. 20 illustrates comparison of average pretilt angle according to Reference 2.

FIG. 21 illustrates comparison of contents of photocuring agents in a liquid crystal layer according to Reference 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art.

In the drawing figures, the dimensions of layers and regions may be exaggerated for clarity of illustration. Like reference numerals refer to like elements throughout.

It will be understood that when an element or layer is referred to as being “on,” “connected to,” or “coupled to” another element or layer, the element or layer can be directly on, connected, or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically, and/or fluidly connected to each other.

As used herein, the term “and/or” includes any and all combinations of one or more of the associated listed items.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section.

Spatially relative terms, such as “bottom,” “below,” “lower,” “under,” “above,” “upper,” “top,” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and mean within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

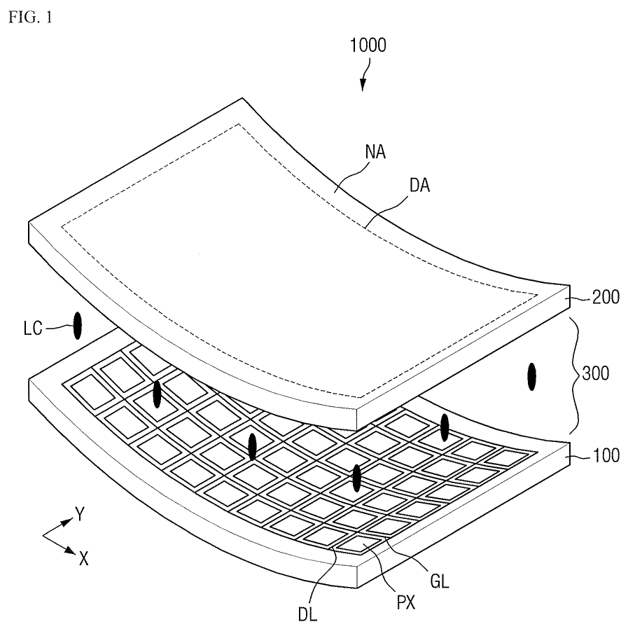

FIG. 1 is a schematic exploded perspective view of an example embodiment of a display device.

In the present example embodiment shown in FIG. 1, a liquid crystal display (LCD) 1000 includes a first substrate 100 which includes a first surface, a first alignment layer and a photocurable layer which are disposed on the first surface of the first substrate 100, a second substrate 200 which includes a first surface facing the first substrate 100 and a second surface from which light exits, a second alignment layer (not illustrated) which is disposed on the first surface of the second substrate 200, and a liquid crystal layer 300 which is interposed between the first substrate 100 and the second substrate 200. The first substrate 100 may be a lower display substrate, the second substrate 200 may be an upper display substrate, and the second surface of the second substrate 200 may be a display surface which displays an image viewed by a viewer.

Each of the first substrate 100 and the second substrate 200 includes a display area DA and a non-display area NA. The display area DA is an area in which an image is displayed, and the non-display area NA is an area in which no image is displayed. The display area DA is surrounded by the non-display area NA.

The display area DA includes a plurality of gate lines GL extending in a first direction X (a row direction), a plurality of data lines DL extending in a second direction Y (a column direction) intersecting the first direction X, and a plurality of pixel areas PX defined at intersections of the gate lines GL and the data lines DL. The pixel areas PX may be arranged in the row direction and the column direction in a substantially matrix pattern.

Each of the pixel areas PX may display one of primary colors. The primary colors may be, for example, red, green, and blue.

The non-display area NA may be a light-blocking area. A gate driver which provides gate signals to pixels of the display area DA and a data driver which provides data signals to the pixels of the display area DA may be disposed in the non-display area NA of the LCD 1000. The gate lines GL and the data lines DL may extend from the display area DA to the non-display area NA and may be electrically connected to the gate driver and the data driver.

A backlight unit may be disposed under the first substrate 100 to irradiate light from under a display panel including the first substrate 100 and the second substrate 200. The backlight unit may include a light source, a light guide plate (LGP) which guides light emitted from the light source toward the display panel, a reflective sheet which is disposed under the LGP, and one or more optical sheets which are disposed on the LGP and improve luminance characteristics of light proceeding toward the display panel.

Referring to FIG. 1, the LCD 1000 according to the current embodiment may be a curved LCD having the first substrate 100 and the second substrate 200 curved from a plane along at least the first direction X. Here, the first surface of the first substrate 100 and/or the second surface (the display surface) of the second substrate 200 may be bent concavely. For ease of description, the curved LCD according to the current embodiment will be illustrated as a flat LCD in the following cross-sectional views.

Components of the LCD 1000 according to the current embodiment will now be described in greater detail.

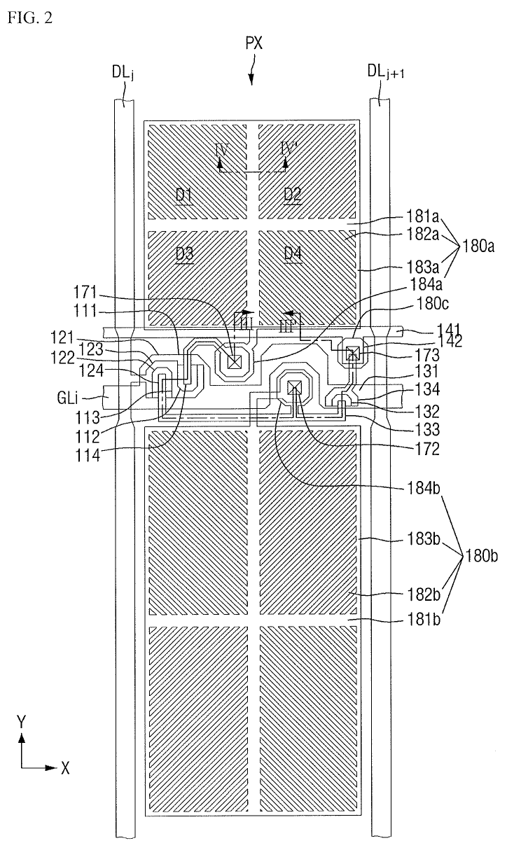

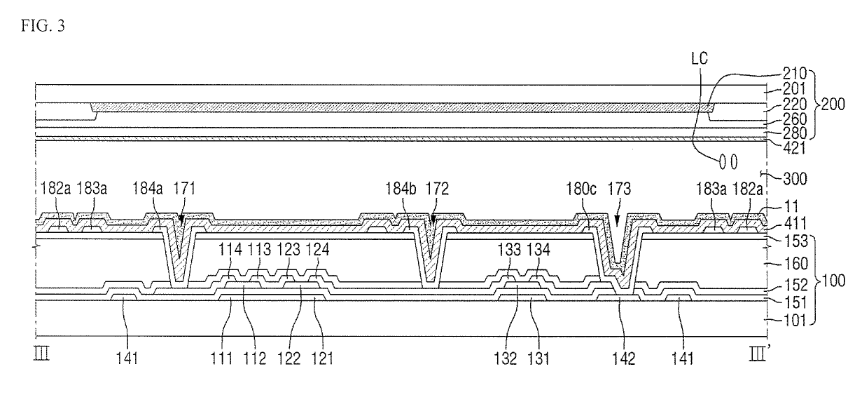

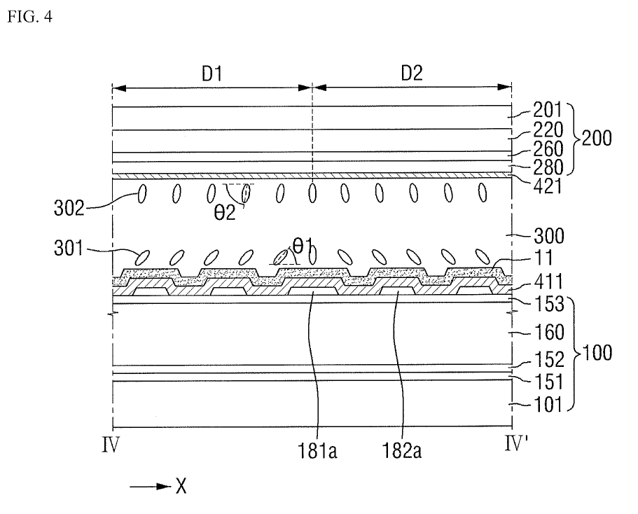

FIG. 2 is a schematic layout view of a pixel illustrated in FIG. 1. FIG. 3 is a cross-sectional view taken along line of FIG. 2. FIG. 4 is a cross-sectional view taken along line IV-IV′ of FIG. 2.

Referring to FIGS. 2 through 4, the first substrate 100 includes a first base substrate 101, a plurality of thin-film transistors (TFTs), a pixel electrode, and a plurality of passivation/insulation layers.

The first base substrate 101 may be a transparent insulating substrate and may be made of a material having superior light-transmitting, heat-resistant, and chemical resistance properties. For example, the first base substrate 101 may be a silicon substrate, a glass substrate, or a plastic substrate.

A gate wiring layer is disposed on the first base substrate 101. The gate wiring layer may include a gate line GLi, a plurality of gate electrodes, and a reference voltage line 141.

The gate line GLi extends along substantially the first direction X. A first gate electrode 111 and a second gate electrode 121 may protrude upward from the gate line GLi. The first gate electrode 111 and the second gate electrode 121 may be integrally formed with each other without a physical boundary therebetween. For example, the first gate electrode 111 may be located further to the right than the second gate electrode 121. In addition, a third gate electrode 131 may be defined in an area which overlaps the gate line GLi. Thus, the first through third gate electrodes 111 through 131 may be connected to the same gate line GLi and receive the same gate signal from the gate line GLi.

The reference voltage line 141 may be disposed on the same layer as the gate line GLi and the first through third gate electrodes 111 through 131 and extend substantially parallel to the gate line GLi. A reference voltage may be applied to the reference voltage line 141.

The reference voltage line 141 further includes a reference voltage electrode 142. The reference voltage electrode 142 protrudes downward from the reference voltage line 141 and has a wide surface that can stably contact a third drain electrode 134. Unlike in the drawings including FIG. 2, in some embodiments, the reference voltage line 141 may further include a storage electrode and/or a storage electrode line. In this case, the storage electrode may protrude from the reference voltage line 141 and may form a storage capacitor with a data wiring layer disposed on the storage electrode to overlap the storage electrode and a plurality of passivation/insulation layers disposed between the storage electrode and the data wiring layer. In addition, the storage electrode line may protrude from the reference voltage line 141 and overlap at least part of an edge portion of the pixel electrode. Thus, the storage electrode line may be formed along edges of the pixel electrode; in some other embodiments, the storage electrode and/or the storage electrode line may be omitted or formed in a different shape and at a different position.

The gate wiring layer may be formed by forming a first metal layer and patterning the first metal layer. Here, the first metal layer may include an alloy material or a compound material having an element selected from tantalum (Ta), tungsten (W), titanium (Ti), molybdenum (Mo), aluminum (Al), copper (Cu), silver (Ag), chrome (Cr), and neodymium (Nd), or having the element as a main component. The patterning of the first metal layer may be performed using a mask process or various other methods of forming patterns.

A gate insulation layer 151 is disposed on the gate wiring layer and over the whole surface of the first base substrate 101. The gate insulation layer 151 may be made of an insulating material to electrically insulate elements located thereon and elements located thereunder. Examples of the material that forms the gate insulation layer 151 may include silicon nitride (SiNₓ), silicon oxide (SiOₓ), silicon nitride oxide (SiNₓO_{y}), and silicon oxynitride (SiOₓN_{y}). The gate insulation layer 151 may have a multilayer structure including at least two insulation layers having different physical characteristics.

A semiconductor material layer is disposed on the gate insulation layer 151. The semiconductor material layer may include a first semiconductor layer 112, a second semiconductor layer 122, and a third semiconductor layer 132. The first through third semiconductor layers 112 through 132 may overlap at least part of the first through third gate electrodes 111 through 131, respectively. The semiconductor material layer may be made of a semiconductor material such as amorphous silicon, polycrystalline silicon, or oxide semiconductor. The first through third semiconductor layers 112 through 132 may serve as channels of the TFTs and turn on or off the channels according to voltages provided to the first through third gate electrodes 111 through 131.

A data wiring layer is disposed on the semiconductor material layer. The data wiring layer may include a plurality of data lines DLj and DLj+1, a plurality of source electrodes, and a plurality of drain electrodes.

The data line DLj extends along substantially the second direction Y to intersect the gate line GLi. A data signal may be transmitted to the data line DLj. A pixel area PX is defined at an intersection of the data line DLj and the gate line GLi. Each pixel area PX may be an area operated independently by the TFTs connected to the gate line GLi and the data line DLj.

A first source electrode 113 and a first drain electrode 114 are disposed on the first gate electrode 111 and the first semiconductor layer 112 to be separated from each other. A second source electrode 123 and a second drain electrode 124 are disposed on the second gate electrode 121 and the second semiconductor layer 122 to be separated from each other. A third source electrode 133 and the third drain electrode 134 are disposed on the third gate electrode 131 and the third semiconductor layer 132 to be separated from each other. For example, the first and second source electrodes 113 and 123 may surround at least part of the first and second drain electrodes 114 and 124, respectively. In addition, the third drain electrode 134 may surround at least part of the third source electrode 133. In another implementation, for example, each of the first and second source electrodes 113 and 123 and the third drain electrode 134 may have a C shape, a U shape, an inverted C shape, or an inverted U shape. The first source electrode 113 and the second source electrode 123 may be integrally formed with each other without a physical boundary therebetween and may protrude to the right from the data line DLj. The third source electrode 133 may be physically connected to the second drain electrode 124. The first drain electrode 114 may be electrically connected to a first subpixel electrode 180a by a first contact hole 171, the second drain electrode 124 may be electrically connected to a second subpixel electrode 180b by a second contact hole 172, and the third drain electrode 134 may be electrically connected to the reference voltage electrode 142 by a third contact hole 173 and a contact electrode 180c.

The data wiring layer may be formed by forming a second metal layer and patterning the second metal layer. Here, the second metal layer may include a refractory metal such as silver (Ag), gold (Au), copper (Cu), nickel (Ni), platinum (Pt), palladium (Pd), iridium (Ir), rhodium (Rh), tungsten (W), aluminum (Al), tantalum (Ta), molybdenum (Mo), cadmium (Cd), zinc (Zn), iron (Fe), titanium (Ti), silicon (Si), germanium (Ge), zirconium (Zr), or barium (Ba), an alloy of these metals, or a metal nitride of these metals.

An ohmic contact layer may be disposed between the semiconductor material layer and the data wiring layer. The ohmic contact layer may be made of, for example, an n+ hydrogenated amorphous silicon material heavily doped with an n-type impurity or may be made of silicide.

Insulation layers including a first passivation layer 151, a planarization layer 160, and a second passivation layer 153 may be disposed on the data wiring layer, and over the whole surface of the first base substrate 101. The insulation layers may be made of an organic layer and/or an inorganic layer. In some embodiments, each of the first passivation layer 151, the planarization layer 160, and the second passivation layer 153 may have a multilayer structure.

The first passivation layer 152 may be made of an inorganic insulating material such as silicon nitride or silicon oxide. The first passivation layer 152 may prevent wiring layers and electrodes formed thereunder from directly contacting an organic material. The planarization layer 160 made of an organic material may be disposed on the first passivation layer 152. The planarization layer 160 may make heights of a plurality of components stacked on the first base substrate 101 equal. The second passivation layer 153 may be disposed on the planarization layer 160. The second passivation layer 153 may prevent a defect, such as an afterimage created during screen driving, by suppressing the contamination of the liquid crystal layer 300 due to organic matter (e.g., a solvent) introduced from the planarization layer 160.

Contact holes are formed in the insulation layers including the first passivation layer 152, the planarization layer 160 and the second passivation layer 153 to partially expose the first through third drain electrodes 114 through 134 and the reference voltage electrode 142. For example, the first contact hole 171 partially exposes the first drain electrode 114, the second contact hole 172 partially exposes the second drain electrode 124, and the third contact hole 173 partially exposes the third drain electrode 134 and the reference voltage electrode 142.

The pixel electrode and the contact electrode 180c are disposed on the second passivation layer 153. The contact electrode 180c may overlap the third contact hole 173 to contact both the reference voltage electrode 142 and the third drain electrode 134, thereby electrically connecting the reference voltage electrode 142 and the third drain electrode 134. The contact electrode 180c may be formed of the same material as the pixel electrode 180 in the same process.

The pixel electrode corresponds to the pixel area PX. The pixel electrode may form a vertical electric field together with a common electrode 280 of the second substrate 200, thereby controlling the alignment direction of liquid crystal molecules LC in the liquid crystal layer 300 interposed between the pixel electrode and the common electrode 280. The pixel electrode may be a transparent electrode. Examples of the material that forms the transparent electrode may include, for example, indium tin oxide (ITO) and indium zinc oxide (IZO). The pixel electrode includes the first subpixel electrode 180a and the second subpixel electrode 180b which are separated from each other in the second direction Y.

The first subpixel electrode 180a may be substantially quadrilateral and may be a patterned electrode having domain partition means. For example, the first subpixel electrode 180a may include a first central electrode 181a, a plurality of first branch electrodes 182a which extend from the first central electrode 181a, a first edge electrode 183a which is located in an edge portion of the first subpixel electrode 180a and connects the first branch electrodes 182a, and a first protruding electrode 184a which protrudes from the first edge electrode 183a.

The central electrode 181a may be roughly cross (+)-shaped. The first branch electrodes 182a may extend radially from the cross-shaped central electrode 181a in a sloping direction, e.g., in a direction at an angle of approximately 45 degrees to the first central electrode 181a. Therefore, the first subpixel electrode 180a may have four domains which are separated by the first central electrode 181a and in which the first branch electrodes 182a extend in different directions. The domains, as used herein, are referred to as first through fourth domains D1 through D4 in a clockwise direction from an upper left domain. The domains serve as directors of the liquid crystal molecules LC, thus causing the liquid crystal molecules LC to tilt in different directions. Accordingly, this can improve the control over liquid crystals, increase a viewing angle, reduce texture, and improve transmittance and response speed.

At least some of the first branch electrodes 182a extending radially may be connected to each other by the first edge electrode 183a which connects ends of the first branch electrodes 182a. In addition, the first protruding electrode 184a having a large area may protrude downward from the first subpixel electrode 180a to stably contact the first drain electrode 114 through the first contact hole 171. In this case, a data voltage from the data line DLj may be applied to the first subpixel electrode 180a.

The second subpixel electrode 180b may include a second central electrode 181b, a plurality of second branch electrodes 182b which extend from the second central electrode 181b, a second edge electrode 183b which is located in an edge portion of the second subpixel electrode 180b and connects the second branch electrodes 182b, and a second protruding electrode 184b which protrudes from the second edge electrode 183b. The second subpixel electrode 180b has substantially the same shape as the first subpixel electrode 180a. However, the second subpixel electrode 180b may be shaped like a rectangle longer in the second direction Y than in the first direction X and may have a larger planar area than the first subpixel electrode 180a. For example, a ratio of the planar areas of the first subpixel electrode 180a and the second subpixel electrode 180b may be approximately 1:2 to 1:10.

The second protruding electrode 184b having a large area may protrude upward from the second subpixel electrode 180b to stably contact the second drain electrode 124 through the second contact hole 172. In this case, a voltage having a magnitude between a data voltage from the data line DLj and a reference voltage from the reference voltage line 141 may be applied to the second subpixel electrode 180b.

In one pixel area PX, an electric field is generated in a portion (hereinafter, referred to as a first liquid crystal capacitor) of the liquid crystal layer 300 which overlaps the first subpixel electrode 180a by a difference between a data voltage and a common voltage. Therefore, a relatively higher voltage is charged in the first liquid crystal capacitor than in a second liquid crystal capacitor, which will be described below, to control liquid crystals. In addition, an electric field is generated in a portion (hereinafter, referred to as the second liquid crystal capacitor) of the liquid crystal layer 300 by a difference between a voltage lower than the data voltage and the common voltage. Therefore, a relatively lower voltage is charged in the second liquid crystal capacitor than in the first liquid crystal capacitor to control liquid crystals.

The first liquid crystal capacitor charged with a relatively high voltage may undermine lateral visibility at low gray levels at which liquid crystal molecules are aligned vertically, and the second liquid crystal capacitor charged with a relatively low voltage may undermine lateral visibility at intermediate and high gray levels at which the alignment of the liquid crystal molecules becomes close to horizontal alignment. Thus, the voltages charged in the two liquid crystal capacitors may show different gamma curves, and a gamma curve for one pixel voltage perceived by a viewer is a synthesis of the these gamma curves. Lateral visibility may be improved by converting image data such that the synthesized gamma curve at the front matches the most suitable front reference gamma curve and that the synthesized gamma curve at the side is as close to the front reference gamma curve as possible.

The above pixel electrode is merely an example. In some embodiments, the pixel electrode may be bent with respect to the gate line GLi and the data line DLj. In another implementation, the pixel electrode may include branch electrodes of various shapes, or only one pixel electrode formed as a single piece may be disposed in one pixel area which displays one color.

A first alignment layer 411 and a photocurable layer 11 are formed over the whole surface of the first substrate 100 having the first base substrate 101, the TFTs, the pixel electrode, and the passivation/insulation layers.

The first alignment layer 411 may be a vertical alignment layer that contains a polymer material, for example, polyimide having an imide group (—CONHCO—) in a repeating unit of a main chain and at least one vertical alignment group introduced to a side chain thereof. The vertical alignment group may be selected from an alkyl group, a hydrocarbon derivative having an end substituted with an alkyl group, a hydrocarbon derivative having an end substituted with a cycloalkyl group, and a hydrocarbon derivative having an end substituted with an aromatic hydrocarbon. The liquid crystal molecules LC in the liquid crystal layer 300 may be induced to be aligned vertically by the vertical alignment group within the first alignment layer 411.

The polyimide contained in the first alignment layer 411 may include at least some side chains substituted with a polymerization initiator in addition to the side chain substituted with the vertical alignment group. The polymerization initiator may be a photopolymerization initiator. In this case, the photopolymerization initiator may generate radicals by absorbing ultraviolet (UV) light and thus facilitate a polymerization reaction. As the concentration of the polymerization initiator increases, more mesogen polymers, which will be described below, may be formed. In some embodiments, the polymerization initiator may exist in the form of an additive compound added in the first alignment layer 411.

For example, the polymerization initiator may be one or a combination of, for example, acetophenone, benzoin, benzophenone, diethoxy acetophenone, phenylketone, thioxanthone, 2-hydroxy-2-methyl-1-phenylpropan-1-on, benzyl dimethyl tar, 4-(2-hydroxy ethoxy)phenyl-(2-hydroxy)-2-propyl ketone, 1-hydroxycyclohexylphenyl ketone, o-benzoylbenzoic acid methyl, 4-phenyl benzophenone, 4-benzoyl-4′-methyl-diphenyl sulfide, (4-benzoyl benzyl)trimethyl ammonium chloride, bis(2,4,6-trimethylbenzoyl)-phenylphosphine oxide, diphenyl(2,4,6-trimethylbenzoyl)-phosphine oxide, 2-hydroxy methyl propionitrile, 2,2′-{azobis(2-methyl-N-[1,1′-bis(hydroxymethyl)-2-hydroxyethyl)propionamide]}, acrylic acid [(2-methoxy-2-phenyl-2-benzoyl)-ethyl]ester, phenyl 2-acryloyloxy-2-propyl ketone, phenyl 2-methacryloyloxy-2-propyl ketone, 4-isopropylphenyl 2-acryloyloxy-2-propyl ketone, 4-chlorophenyl 2-acryloyloxy-2-propyl ketone, 4-dodecylphenyl 2-acryloyloxy-2-propyl ketone, 4-methoxyphenyl 2-acryloyloxy-2-propyl ketone, 4-acryloyloxyphenyl 2-hydroxy-2-propyl ketone, 4-methacryloyloxyphenyl 2-hydroxy-2-propyl ketone, 4-(2-acryloyloxyethoxy)-phenyl 2-hydroxy-2-propyl ketone, 4-(2-acryloyloxydiethoxy)-phenyl 2-hydroxy-2-propyl ketone, 4-(2-acryloyloxyethoxy)-benzoin, 4-(2-acryloyloxyethylthio)-phenyl 2-hydroxy-2-propyl ketone, 4-N,N′-bis-(2-acryloyloxyethyl)-aminophenyl 2-hydroxy-2-propyl ketone, 4-acryloyloxyphenyl 2-acryloyloxy-2-propyl ketone, 4-methacryloyloxyphenyl 2-methacryloyloxy-2-propyl ketone, 4-(2-acryloyloxyethoxy)-phenyl 2-acryloyloxy-2-propyl ketone, 4-(2-acryloyloxydiethoxy)-phenyl 2-acryloyloxy-2-propyl ketone, dibenzyl ketone, benzoin alkyl ether, benzoin methyl ether, benzoin ethyl ether, benzoin isopropyl ether, benzoin isobutyl ether, dialkyl acetophenone, hydroxyl alkylketone, phenyl glyoxylate, benzyl dimethyl ketal, acyl phosphine, and α-aminoketone.

In some embodiments, the polyimide contained in the first alignment layer 411 may include at least some side chains substituted with an ion scavenger (ion capture) in addition to the side chains substituted with the vertical alignment group and the polymerization initiator. The ion scavenger may be a cationic scavenger or an anionic scavenger. The ion scavenger may improve a voltage holding ratio (VHR) of the LCD 1000 by capturing ion impurities within the liquid crystal layer 300.

The photocurable layer 11 at least partially including an azobenzene group may be formed on the first alignment layer 411. The photocurable layer 11 may be formed by polymerization of mono-molecules of a photocuring agent or by the formation of a polymer compound, in which the mono-molecules of the photocuring agent are chemically bonded to the vertical alignment group of the polyimide in the first alignment layer 411, in the form of fine protrusions to cover a surface of the first alignment layer 411. The photocuring agent may be reactive mesogens, and the polymer compound may be polymers of the reactive mesogens.

A reactive mesogen is a compound having a mesogen group (a rigid group) for liquid crystal properties and a polymerizable end group (a reactive group) for polymerization. The reactive mesogen may be a crosslinkable low or high molecular weight molecule and may cause a chemical reaction, such as a polymerization reaction, when absorbing light of a particular wavelength and/or heat.

The rigid group of the reactive mesogen may include an azobenzene group at its center portion, and the polymerizable end group may include, for example, methacrylate, acrylate, vinyl, vinyloxy, epoxy, etc. For example, the polymerizable end group may be any one of

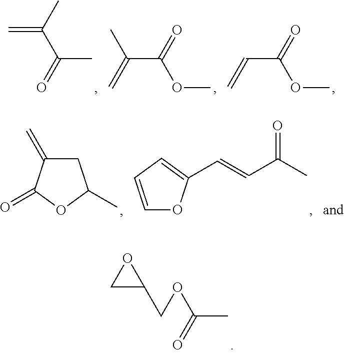

In addition, the reactive mesogen may have a bar structure, a banana structure, a board structure, or a disc structure.

In an example embodiment, the reactive mesogen may include a compound structured as in Chemical Formula (1) below:

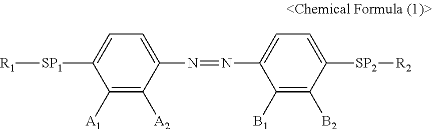

In Chemical Formula (1), each of R₁ and R₂ may independently be a methacrylate group, an acrylate group, a vinyl group, a vinyloxy group, or an epoxy group, each of SP₁ and SP₂ may independently be a single bond, an alkyl group having 1 to 12 carbon atoms, or an alkoxy group having 1 to 12 carbon atoms, each of A₁ and A₂ may independently be hydrogen or a halogen, and each of B₁ and B₂ may independently be hydrogen or a halogen. In an implementation, at least one of A₁ and A₂ may be hydrogen, and at least one of B₁ and B₂ may be hydrogen.

In an example embodiment, the reactive mesogen may include a compound structured as in any one of, for example, Chemical Formulae (2) through (5) below:

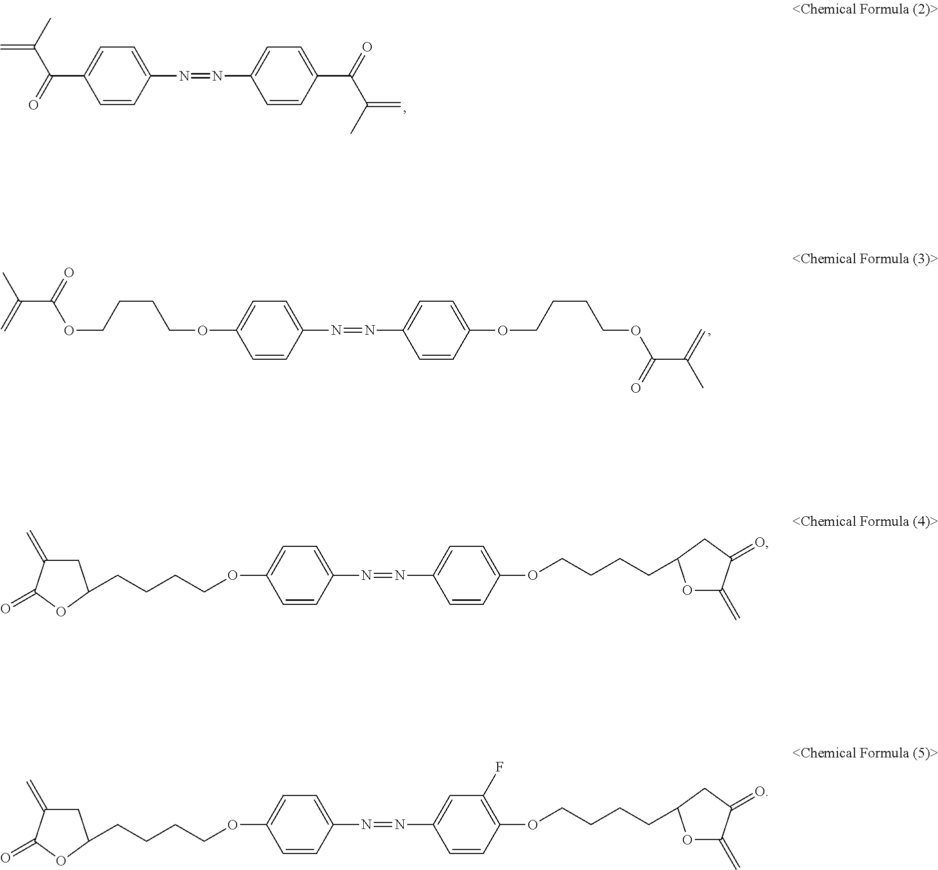 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

The reactive mesogen including an azobenzene group as a rigid group may have a sufficiently long chain length. In addition, an additional double bond and a single bond may be included in the rigid group. Thus, a phase transition temperature due to a thermal reaction may become approximately 200° C. or above, which may improve thermal stability. Moreover, a main optical wavelength range that can induce a photopolymerization reaction may be shifted to relatively longer wavelengths in the case of the reactive mesogen including the azobenzene group than in the case of a reactive mesogen not including the azobenzene group. Accordingly, exposure time and dose may be reduced by matching a wavelength of light used in a photopolymerization process, which will be described below, with a wavelength of light absorbed at the highest rate by the reactive mesogen according to the present example embodiment. The reduced exposure time and dose may improve process efficiency. In addition, photopolymerization may be completed within a relatively short time. Thus, a reduction in VHR due to the damage to liquid crystal molecules may be prevented. Further, unreacted reactive mesogens remaining in the liquid crystal layer may be removed effectively, which may help prevent an afterimage defect.

The photocuring agent may include mesogen polymers formed by polymerization of reactive mesogens. The photocuring agent may form the photocurable layer 11 and include an azobenzene group within a repeating unit. The mesogen polymers that form the photocurable layer 11 may be cured at a predetermined slope and maintain the predetermined slope after being cured. The photocurable layer 11 may affect the pretilt alignment of the liquid crystal molecules LC through an interaction force between the mesogen polymers and adjacent liquid crystal molecules LC and/or a physical force.

The second substrate 200 includes a second base substrate 201, a light-blocking member 210, a color filter 220, an overcoat layer 260, and the common electrode 280.

Like the first base substrate 101, the second base substrate 201 may be a transparent insulating substrate. The light-blocking member 210 is disposed on the second base substrate 201. The light-blocking member 210 may be, for example, a black matrix. The light-blocking member 210 may be disposed in a boundary area between a plurality of pixel areas PX, that is, areas that overlap the data lines DLj and DLj+1 and an area that overlaps the gate line GLi. The light-blocking member 210 may help prevent the unintended mixing of colors or the leakage of light which may occur at a boundary between adjacent pixel areas PX.

The color filter 220 may be disposed on the light-blocking member 210 to overlap the pixel area PX. The color filter 220 may transmit light of a particular wavelength band only. The color filter 220 may be disposed between two neighboring data lines DLj and DLj+1. Color filters which transmit light of different wavelength bands may be disposed in adjacent pixel areas PX. For example, a red color filter may be disposed in a first pixel area, and a green color filter may be disposed in a second pixel area adjacent to the first pixel area.

In the drawings including FIG. 2, the light-blocking member 210 and the color filter 220 are disposed on the second substrate 200. However, one or more of the light-blocking member 210 and the color filter 220 can also be disposed on the first substrate 100.

The overcoat layer 260 made of an organic material may be disposed on the light-blocking member 210 and the color filter 220 and over the whole surface of the second base substrate 201. The overcoat layer 260 may help prevent the light-blocking member 210 from moving out of position from the second base substrate 201, suppress the creation of an afterimage due to pigment particles from the color filter 220, and make components stacked on the second base substrate 201 have uniform heights. In some embodiments, however, the overcoat layer 260 may be omitted.

The common electrode 280 is disposed on the overcoat layer 260. Like the pixel electrode (180a, 180b), the common electrode 280 may be a transparent electrode. The common electrode 280 may overlap most of each pixel area PX.

A second alignment layer 421 is disposed over the whole surface of the second substrate 200 including the second base substrate 201, the light-blocking member 210, the color filter 220, the overcoat layer 260, and the common electrode 280.

The second alignment layer 421 may be a vertical alignment layer that contains a polymer material, for example, polyimide having an imide group in a repeating unit of a main chain and at least one vertical alignment group introduced to a side chain thereof. The vertical alignment group may be selected from an alkyl group, a hydrocarbon derivative having an end substituted with an alkyl group, a hydrocarbon derivative having an end substituted with a cycloalkyl group, and a hydrocarbon derivative having an end substituted with an aromatic hydrocarbon. The liquid crystal molecules LC in the liquid crystal layer 300 may be induced to be aligned vertically by the vertical alignment group within the second alignment layer 421.

In an example embodiment, the polyimide contained in the second alignment layer 421 is different from the polyimide contained in the first alignment layer 411 in that it does not substantially include a side chain substituted with a polymerization initiator or a polymerization initiator additive. As described above, the content of the polymerization initiator in an alignment layer may affect the degree to which a photocurable layer is formed on the alignment layer. Thus, due to the absence of the polymerization initiator from the second alignment layer 421, a photocurable layer may not be formed on the second alignment layer 421, unlike the first alignment layer 411 on which the photocurable layer 11 is formed. In another implementation, a specific photocurable layer having a very small number of mesogen polymers compared with the photocurable layer 11 may be formed on the second alignment layer 421. In this case, due to the photocurable layer 11 formed on the surface of the first alignment layer 411, the surface roughness of the first alignment layer 411 may be greater than that of the second alignment layer 421. This may be because the size of mesogen polymers, the degree of polymerization of the mesogen polymers, and the content of the mesogen polymers per unit area in the photocurable layer 11 formed on the surface of the first alignment layer 411 are greater than those of mesogen polymers in the specific photocurable layer.

In some embodiments, the second alignment layer 421 may include the polymerization initiator in a smaller amount than the first alignment layer 411.

The liquid crystal layer 300 includes first liquid crystal molecules 301 adjacent to the surface of the photocurable layer 11 and second liquid crystal molecules 302 adjacent to the surface of the second alignment layer 421. In particular, the mesogen polymers that form the photocurable layer 11 may be cured at a predetermined slope. Thus, the first liquid crystal molecules 301 may be aligned having a pretilt angle in an initial alignment state by the first alignment layer 411 and the photocurable layer 11. As a result, when an electric field is formed in the liquid crystal layer 300 to drive the LCD 1000, the first liquid crystal molecules 301 may tilt in the direction of the pretilt, thereby improving response speed of the LCD 1000. As used herein, the initial alignment state denotes a state where no electric field has been formed between the first substrate 100 and the second substrate 200 or a state where substantially the same voltage has been applied to the first substrate 100 and the second substrate 200, and the pretilt angle denotes an acute angle formed by long axes of liquid crystal molecules and a virtual tangent line to the surface of the first substrate 100 or the second substrate 200. For example, when liquid crystal molecules are aligned completely vertically to the surface of the first substrate 100 or the second substrate 200, the pretilt angle of the liquid crystal molecules is 90 degrees.

For example, the first liquid crystal molecules 301 adjacent to the first photocurable layer 11 may be aligned at approximately a first pretilt angle θ1, and the second liquid crystal molecules 302 adjacent to the second alignment layer 421 may be aligned at approximately a second pretilt angle θ2 greater than the first pretilt angle θ1. Thus, the second liquid crystal molecules 302 adjacent to the second substrate 200 may be aligned more vertically than the first liquid crystal molecules 301 adjacent to the first substrate 100. For example, the second pretilt angle θ2 may be greater than the first pretilt angle θ1 by more than approximately 1 degree.

Without being bound by theory, it is believed that this may be because no mesogen polymers exist on the surface of the second alignment layer 421 whereas the photocurable layer 11 including the mesogen polymers is formed on the surface of the first alignment layer 411. Even if mesogen polymers exist on the surface of the second alignment layer 421, the degree of polymerization of the mesogen polymers, the size of the mesogen polymers, and/or the content of the mesogen polymers per unit area may be far smaller than those of the mesogen polymers in the photocurable layer 11.

In the initial state where no electric field has been applied to the LCD 1000, if the first liquid crystal molecules 301 are aligned at a certain pretilt angle and if the second liquid crystal molecules 302 are aligned at a pretilt angle greater than the pretilt angle of the first liquid crystal molecules 302 or aligned substantially vertically, stains or dark portions formed by the collision between alignment directions of the first liquid crystal molecules 301 and the second liquid crystal molecules 302 may be reduced.

On the other hand, liquid crystal molecules located in the first domain D1 and liquid crystal molecules located in the second domain D2 have different pretilt directions. For example, the liquid crystal molecules in the first domain D1 may tilt in a lower right direction in the plan view of FIG. 2 (in a right direction in the cross-sectional view of FIG. 4), and the liquid crystal molecules in the second domain D2 may have substantially the same size as the liquid crystal molecules in the first domain D1 but tilt in a different direction, that is, in a lower left direction in the plan view of FIG. 2 (in a left direction in the cross-sectional view of FIG. 4). The formation of domains in which liquid crystal molecules are aligned in different directions may improve viewing angle and response speed.

Hereinafter, a method of manufacturing an LCD according to an example embodiment will be described.

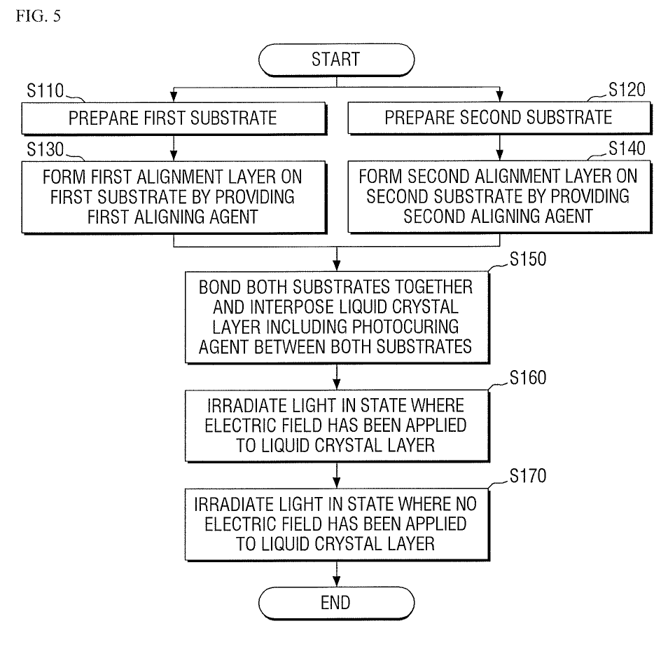

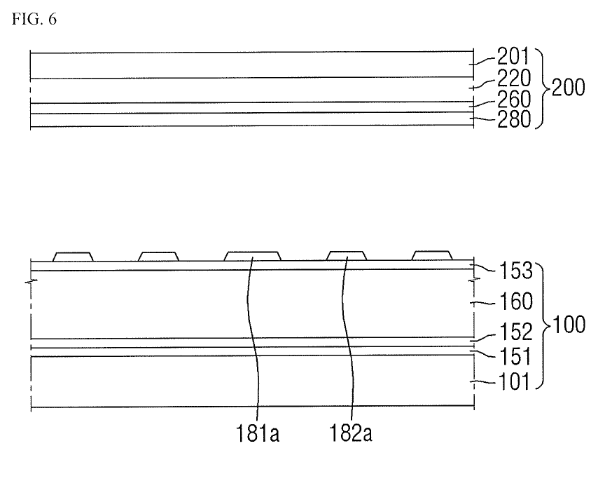

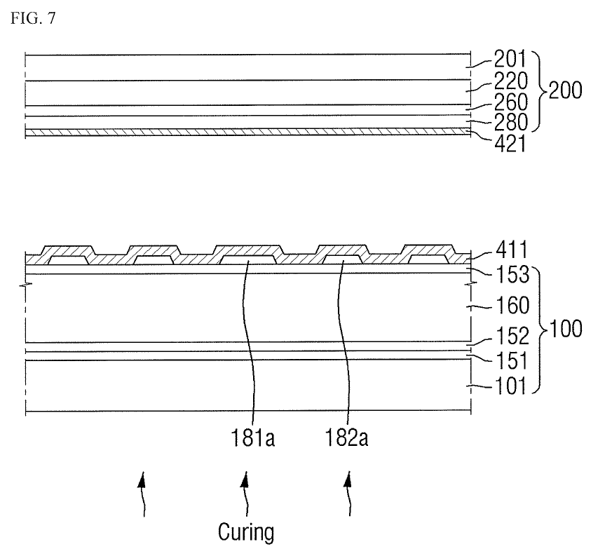

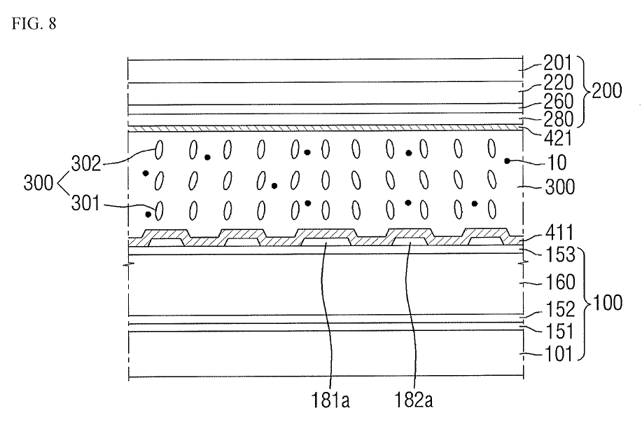

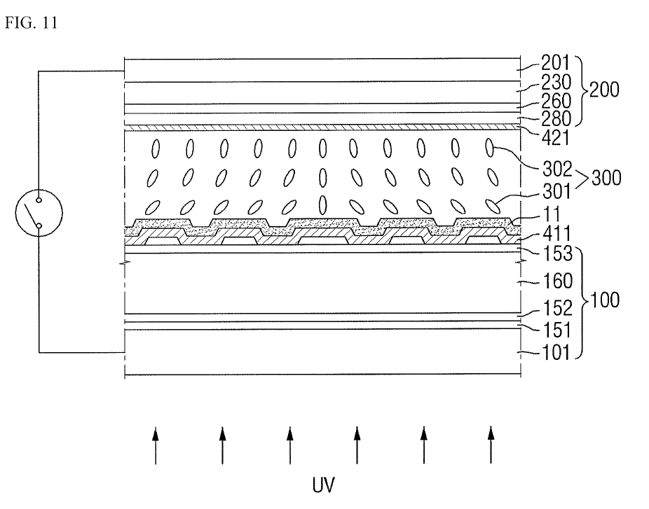

FIG. 5 is a flowchart illustrating an example process of manufacturing an LCD. FIGS. 6 through 11 are cross-sectional views illustrating stages in the manufacturing process of FIG. 5.

Referring to FIGS. 5 and 6, a first substrate 100 is prepared by forming a gate wiring layer, a gate insulation layer 151, a data wiring layer, first and second passivation layers 152 and 153, a planarization layer 160, and a pixel electrode on a first base substrate 101 (operation S110). Then, a second substrate 200 is prepared by forming a light-blocking member (not illustrated), a color filter 220, an overcoat layer 260, and a common electrode 280 on a second base substrate 201 (operation S120). The first substrate 100 may be a lower display substrate, and the second substrate 200 may be an upper display substrate. The positions and shapes of the components included in the first substrate 100 and the second substrate 200 have been described above with reference to FIGS. 2 through 4, and thus a detailed description thereof will not be repeated.

Referring to FIGS. 5 through 7, a first alignment layer 411 is formed on the first substrate 100 by providing a first aligning agent (operation S130). For example, the first aligning agent may include polyimide, which has an imide group in a repeating unit of a main chain and at least some of side chains thereof substituted with a vertical alignment group and a polymerization initiator, and a solvent. The first aligning agent may be provided by, for example, spin coating, slit coating, etc.

After the provision of the first aligning agent, the first alignment layer 411 is formed by curing the first aligning agent. The curing of the first aligning agent may include one or more heat-treatment processes. In an example embodiment, the curing of the first aligning agent may include a first curing operation and a second curing operation. The first curing operation may be a pre-curing operation, and the second curing operation may be a main curing operation or a post-curing operation. The first curing operation and the second curing operation may be performed sequentially. However, in some embodiments, the first curing operation and the second curing operation may be performed substantially continually regardless of order.

The first curing operation may be an operation of removing the solvent contained in the first aligning agent or an operation of inducing layer separation. For example, a curing temperature in the first curing operation may be approximately 50 to 100° C. or approximately 60 to 75° C. In addition, the first curing operation may be performed for approximately 60 to 300 seconds or for approximately 70 to 120 seconds.

The second curing operation may be an operation of substantially completing the polymerization of polyimide polymer monomers or polymer precursors contained in the first aligning agent. The second curing operation may be performed at a higher temperature and for a longer period of time than the first curing operation. For example, a curing temperature in the second curing operation may be approximately 150 to 270° C. or approximately 170 to 250° C. In addition, the second curing operation may be performed for approximately 500 to 1500 seconds or for approximately 700 to 1300 seconds.

Next, a second alignment layer 421 is formed on the second substrate 200 by providing a second aligning agent (operation S140). The second aligning agent may include polyimide having an imide group in a repeating unit of a main chain and at least some of side chains thereof substituted with a vertical alignment group. The second aligning agent may be different from the first aligning agent in that it does not substantially include a polymerization initiator or a side chain substituted with the polymerization initiator. Other components of the second aligning agent may be substantially identical to those of the first aligning agent. After the provision of the second aligning agent, the second alignment layer 421 is formed by curing the second aligning agent. This process may be the same as the process of forming the first alignment layer 411, a detailed description thereof will not be repeated.

Referring to FIGS. 5 through 8, the first substrate 100 and the second substrate 200 are bonded together, and a liquid crystal layer 300 including a photocuring agent 10 is interposed between the first substrate 100 and the second substrate 200 (operation S150). In an example embodiment, the interposing of the liquid crystal layer 300 (operation S150) may be an operation of bonding the first substrate 100 and the second substrate 200 together after dropping a liquid crystal composition onto the first substrate 100 and/or the second substrate 200, or an operation of injecting the liquid crystal composition into between the first substrate 100 and the second substrate 200 after bonding the first substrate 100 and the second substrate 200 together.

The photocuring agent 10 according to the present example embodiment may include a rigid group including an azobenzene group, and may have a phase transition temperature of approximately 200° C. or above in response to a thermal reaction. For example, a maximum peak measured using differential scanning calorimetry (DSC) may appear in a temperature range of approximately 200° C. or above. The photocuring agent 10 will be described in detail below together with a photocurable layer 11.

Liquid crystal molecules within the liquid crystal layer 300 include first liquid crystal molecules 301 adjacent to a surface of the first alignment layer 411 and second liquid crystal molecules 302 adjacent to a surface of the second alignment layer 421. In an initial state in which no electric field has been formed, the first liquid crystal molecules 301 and the second liquid crystal molecules 302 may be aligned substantially vertically by the vertical alignment groups of the polyimides contained in the first alignment layer 411 and the second alignment layer 421, respectively.

In some embodiments, the manufacturing process may further include a heat-treatment operation to improve the spread and uniformity of the liquid crystal molecules after the formation of the liquid crystal layer 300.

Referring to FIGS. 5 through 9, light is irradiated in a state where an electric field has been applied to the liquid crystal layer 300 (operation S160). For example, when a vertical electric field is formed between the first substrate 100 and the second substrate 200, long axes of the liquid crystal molecules within the liquid crystal layer 300 may tilt in a direction perpendicular to the electric field. In addition, as the liquid crystal molecules tilt, the vertical alignment group of the polyimide in each of the first and second alignment layers 411 and 421 and the polymerization initiator in the first alignment layer 411 may tilt at an angle similar to that of the first and second liquid crystal molecules 301 and 302.

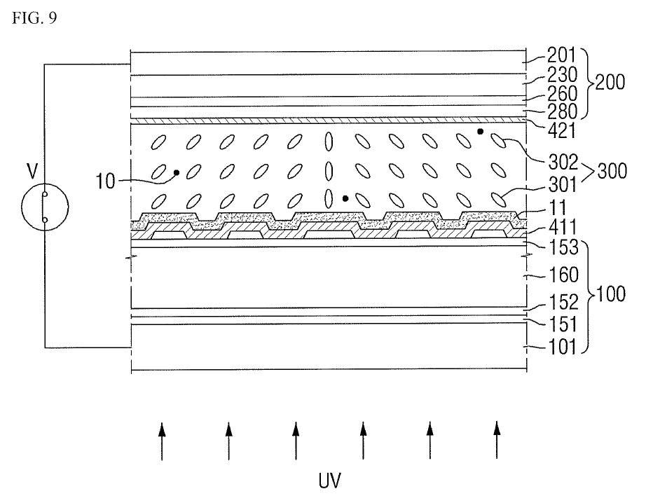

The light may be UV light having a wavelength of approximately 300 to 380 nanometers (nm) or approximately 355 to 365 nm. In addition, the light may be irradiated at an exposure dose of approximately 0.1 to 15 J/cm² or approximately 1 to 4 J/cm². The photocuring agent 10 according to the present example embodiment may have a high absorption rate for light having the above wavelength. Thus, the photocurable layer 11 providing a pretilt angle may be formed with a relatively low exposure dose of, e.g., 4 J/cm² or less. In the drawings including FIG. 9, light is irradiated from the side of the first substrate 100. However, the light can also be irradiated from the side of the second substrate 200 or from both sides.

When light is irradiated to the liquid crystal layer 300 having the photocuring agent 10, a photopolymerization reaction may be induced by the polymerization initiator introduced to a side chain of the polyimide in the first alignment layer 411. As a result, the photocurable layer 11 at least partially including an azobenzene group may be formed on the first alignment layer 411. The photocurable layer 11 may be formed by polymerization of mono-molecules of the photocuring agent 10 or by the formation of a polymer compound, in which the mono-molecules of the photocuring agent 10 are chemically bonded to the vertical alignment group of the polyimide in the first alignment layer 411, in the form of fine protrusions to cover the surface of the first alignment layer 411. Thus, in the irradiating of the light in the state where the electric field has been applied to the liquid crystal layer 300 (operation S160), the photocuring agent 10 reduced in the liquid crystal layer 300 can be understood as having been consumed to form the photocurable layer 11 on the first alignment layer 411. The photocuring agent may be reactive mesogens, and the polymer compound may be polymers of the reactive mesogens.

A rigid group of a reactive mesogen may include an azobenzene group, for example, at its center portion, and a polymerizable end group of the reactive mesogen may include, for example, methacrylate, acrylate, vinyl, vinyloxy, epoxy, etc. For example, the polymerizable end group may be any one of

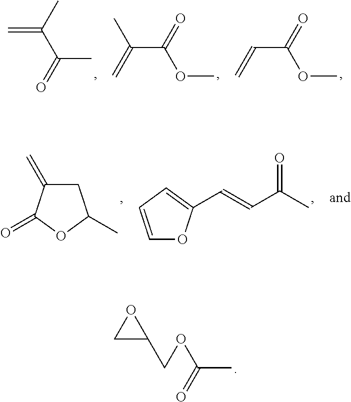

In addition, the reactive mesogen may have a bar structure, a banana structure, a board structure, or a disc structure.

In an example embodiment, the reactive mesogen may include a compound structured as in Chemical Formula (1) below:

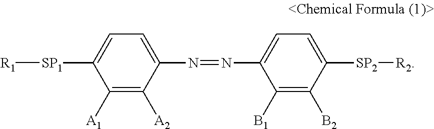

In Chemical Formula (1), each of R₁ and R₂ may independently be a methacrylate group, an acrylate group, a vinyl group, a vinyloxy group, or an epoxy group, each of SP₁ and SP₂ may independently be a single bond, an alkyl group having 1 to 12 carbon atoms, or an alkoxy group having 1 to 12 carbon atoms, each of A₁ and A₂ may independently be hydrogen or a halogen, and each of B₁ and B₂ may independently be hydrogen or a halogen. In an implementation, at least one of A₁ and A₂ may be hydrogen, and at least one of B₁ and B₂ may be hydrogen.

In an example embodiment, the reactive mesogen may include a compound structured as in any one of, for example, Chemical Formulae (2) through (5) below:

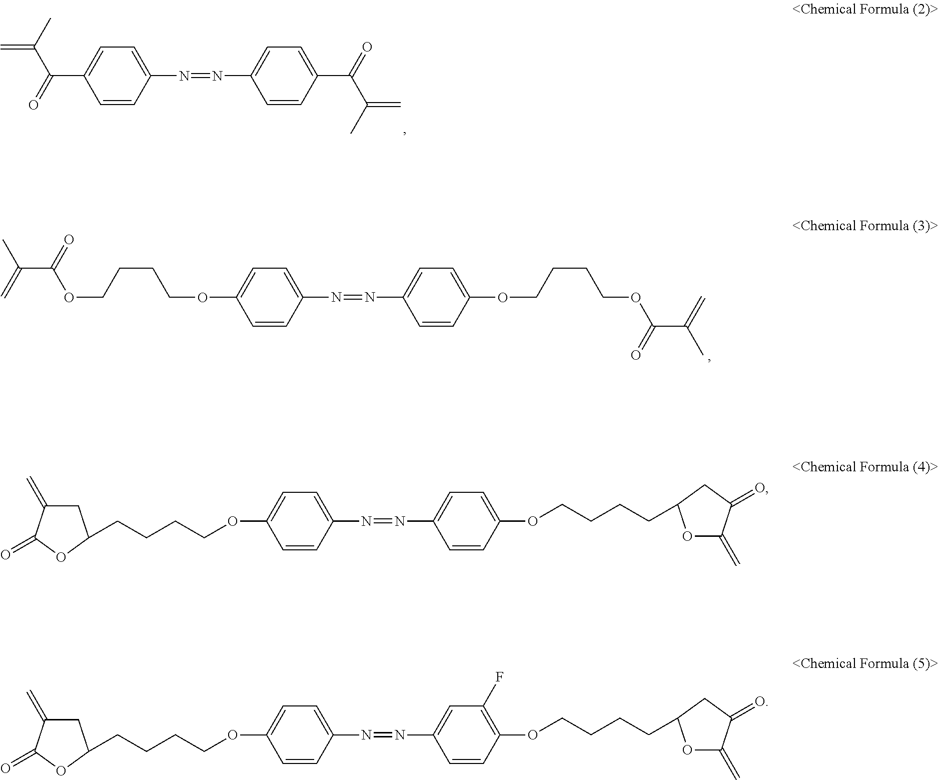 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

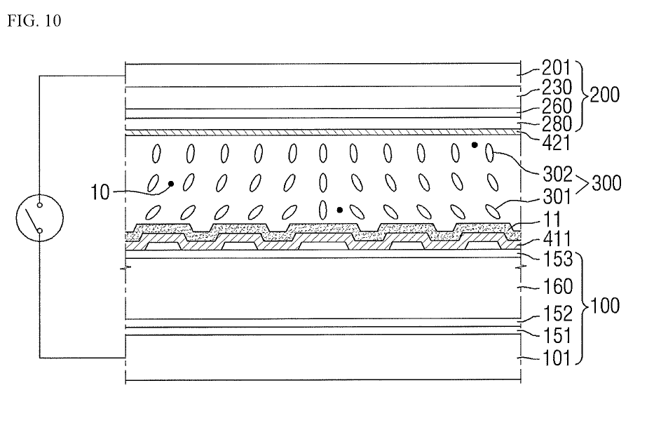

Referring to FIG. 10, the alignment direction of the first liquid crystal molecules 301 is fixed or stabilized by the tilted photocurable layer 11. Therefore, in a state where no electric field has been formed, the first liquid crystal molecules 301 remain at a pretilt angle, whereas the second liquid crystal molecules 302 are aligned substantially vertically. In this case, the first liquid crystal molecules 301 are aligned at approximately a first pretilt angle 01, and the second liquid crystal molecules 302 are aligned at approximately a second pretilt angle θ2 greater than the first pretilt angle θ1. Thus, the second liquid crystal molecules 302 adjacent to the second substrate 200 may be aligned more vertically than the first liquid crystal molecules 301 adjacent to the first substrate 100. An average pretilt angle of the first liquid crystal molecules 301 and the second liquid crystal molecules 302 in the liquid crystal layer 300 may be approximately 88.8 degrees or less, but an appropriate average pretilt angle can be selected by those of skill in the art. After the formation of the photocurable layer 11 on the surface of the first alignment layer 411, the surface roughness of the first alignment layer 411 may be greater than that of the second alignment layer 421. Since this has been described above with reference to FIGS. 2 through 5, a detailed description thereof will not be repeated.

Referring to FIGS. 5 through 11, light is irradiated again in a state where no electric field has been applied to the liquid crystal layer 300 (operation S170). The light may be UV light. The irradiating of the light to the liquid crystal layer 300 may remove the photocuring agent 10 remaining in the liquid crystal layer 300. The light may be irradiated for, for example, approximately 120 minutes or less or approximately 80 minutes or less. The photocuring agent 10 may include the azobenzene group as the rigid group. Thus, it may show a high absorption rate for a wavelength of light used in the re-irradiating of the light (operation S170). Therefore, with a short exposure time and a small exposure dose, most of the remaining photocuring agent 10 may be removed to such an extent not to generate afterimage. This may improve process efficiency and prevent a reduction in VHR by preventing the possible damage to liquid crystal molecules during light irradiation. In this case, the content of the photocuring agent 10 remaining in the liquid crystal layer 300 may be approximately 100 parts per million (ppm) or less.

In the re-irradiating of the light (operation S170), the second liquid crystal molecules 302 may still remain vertically aligned compared with the first liquid crystal molecules 301.

Next, both ends of the first substrate 100 and the second substrate 200 may be bent, and a backlight unit may be provided under the first substrate 100, thereby producing a curved LCD.

A method of manufacturing an LCD according to another example embodiment will now be described. For clarity, description of components substantially identical or similar to those of the method of manufacturing an LCD according to the previous embodiment will be omitted.

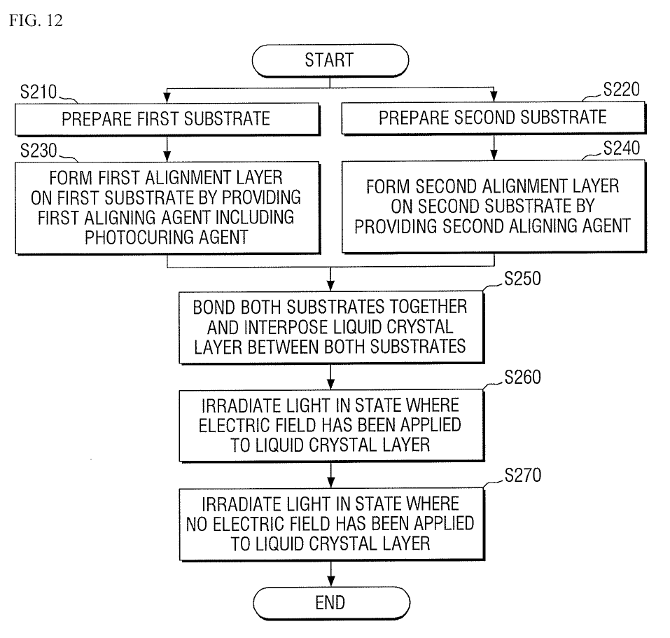

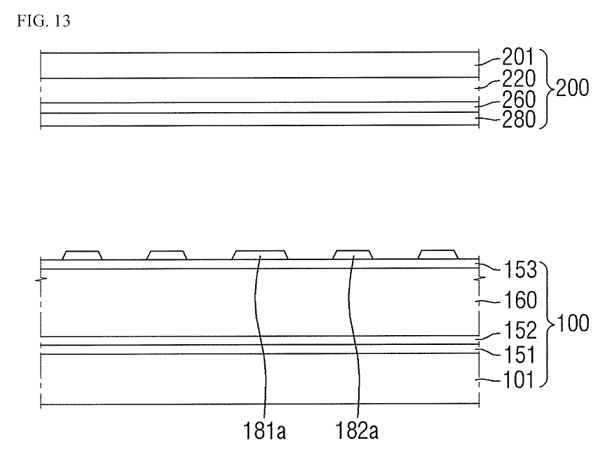

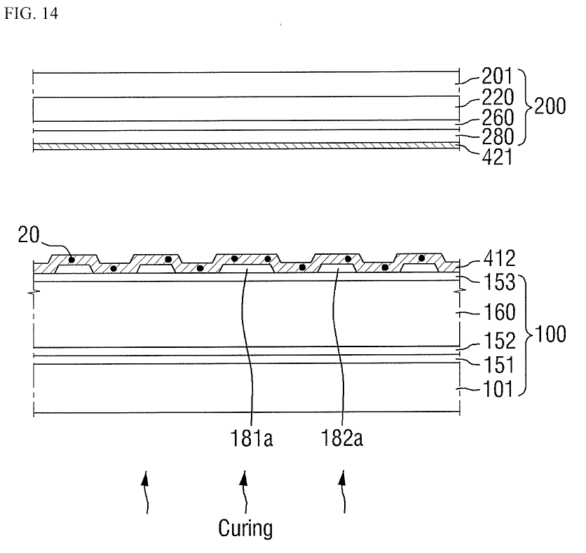

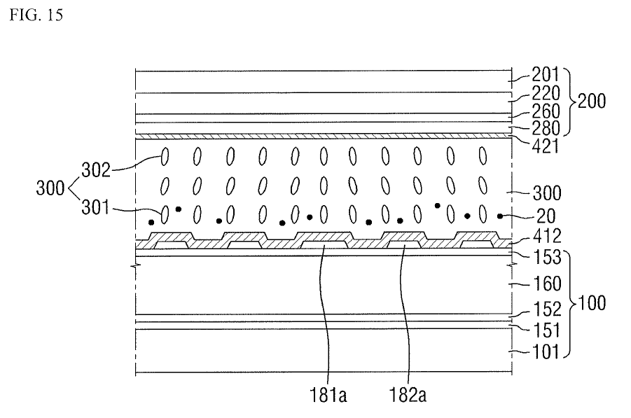

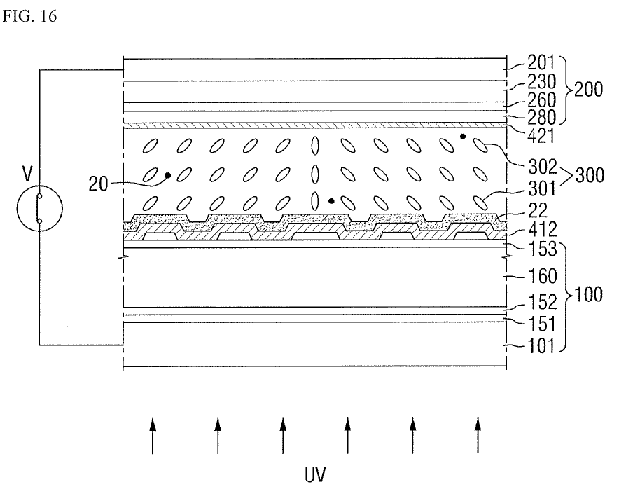

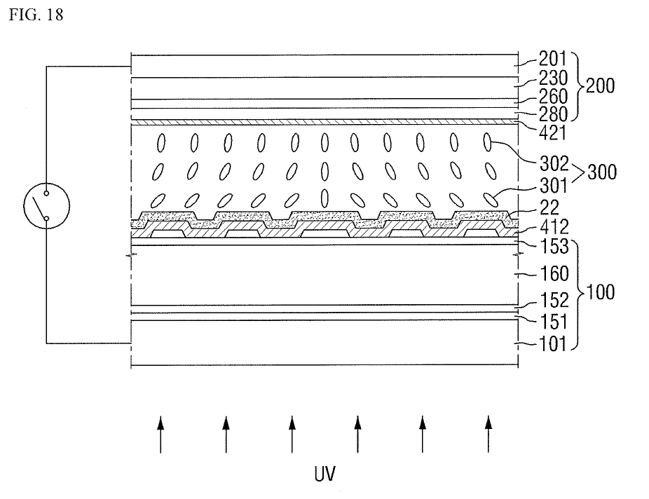

FIG. 12 is a flowchart illustrating another example process of manufacturing an LCD. FIGS. 13 through 18 are cross-sectional views illustrating stages in the manufacturing process of FIG. 12.

Referring to FIGS. 12 and 13, a first substrate 100 is prepared (operation S210). Then, a second substrate 200 is prepared (operation S220). The first substrate 100 may be a lower display substrate, and the second substrate 200 may be an upper display substrate.

Referring to FIGS. 12 through 14, a first alignment layer 412 is formed on the first substrate 100 by providing a first aligning agent including a photocuring agent 20 (operation S230). For example, the first aligning agent may include polyimide, which has an imide group in a repeating unit of a main chain and at least some of side chains thereof substituted with a vertical alignment group and a polymerization initiator, the photocuring agent 20, and a solvent.

After the provision of the first aligning agent, the first alignment layer 412 is formed by curing the first aligning agent. The curing of the first aligning agent may include one or more heat-treatment processes. In an example embodiment, the curing of the first aligning agent may include a first curing operation and a second curing operation. The first curing operation may be a pre-curing operation, and the second curing operation may be a main curing operation or a post-curing operation. The first curing operation and the second curing operation may be performed sequentially. However, in some embodiments, the first curing operation and the second curing operation may be performed substantially continually regardless of order.

The first curing operation may be an operation of removing the solvent contained in the first aligning agent or an operation of inducing layer separation. For example, a curing temperature in the first curing operation may be approximately 50 to 100° C. or approximately 60 to 75° C. In addition, the first curing operation may be performed for approximately 60 to 300 seconds or for approximately 70 to 120 seconds.

The second curing operation may be an operation of substantially completing the polymerization of polyimide polymer monomers or polymer precursors contained in the first aligning agent. The second curing operation may be performed at a higher temperature and for a longer period of time than the first curing operation. For example, a curing temperature in the second curing operation may be approximately 150 to 270° C. or approximately 170 to 230° C. In addition, the second curing operation may be performed for approximately 500 to 1500 seconds or for approximately 700 to 1300 seconds.

In the forming of the first alignment layer 412 by curing the first aligning agent, a high curing temperature of 200° C. or above may cause at least part of the photocuring agent 20 to disappear through thermal decomposition or thermal polymerization. A reduction in the content of monomers of the photocuring agent 20 for forming a photocuring layer 22 may lead to a reduction in the absolute amount of a polymer compound, i.e., mesogen polymers of the photocuring agent 20, thus resulting in the formation of an insufficient pretilt angle of liquid crystal molecules. Further, polymers of the photocuring agent 20 thermally decomposed or thermally polymerized in the curing of the first aligning agent (operation S230) may no longer polymerize in a subsequent light irradiation operation (operation S260). Thus, the polymers of the photocuring agent 20 may remain in a liquid crystal layer 300 as impurities, causing an afterimage defect during the driving of an LCD. In the photocuring agent 20 according to the present example embodiment, a rigid group including an azobenzene group may be long enough to resist a thermal reaction. In addition, an additional double bond and a single bond may be included in the rigid group. Thus, a phase transition temperature due to a thermal reaction may become approximately 200° C. or above. For example, a maximum peak measured using DSC may appear in a temperature range of approximately 200° C. or above. Accordingly, the amount of the photocuring agent 20 thermally decomposed or thermally polymerized in the curing of the first aligning agent (operation S230) can be minimized. A detailed description of the photocuring gent 20 will be described in detail later together with the photocurable layer 22.

Next, a second alignment layer 421 is formed on the second substrate 200 by providing a second aligning agent (operation S240). The second aligning agent may include polyimide having an imide group in a repeating unit of a main chain and at least some of side chains thereof substituted with a vertical alignment group. In the current embodiment, the second aligning agent is different from the first aligning agent in that it does not substantially include a polymerization initiator or a side chain substituted with the polymerization initiator and a photocuring agent. Other components of the second aligning agent may be identical to those of the first aligning agent. After the provision of the second aligning agent, the second alignment layer 421 may be formed by curing the second aligning agent. This process may be the same as the process of forming the first alignment layer 412. Thus, a detailed description thereof will not be repeated.

Referring to FIGS. 12 through 15, the first substrate 100 and the second substrate 200 are bonded together, and the liquid crystal layer 300 is interposed between the first substrate 100 and the second substrate 200 (operation S250). In an example embodiment, the interposing of the liquid crystal layer 300 (operation S250) may use an operation of dropping or injecting a liquid crystal composition.

Liquid crystal molecules within the liquid crystal layer 300 include first liquid crystal molecules 301 adjacent to a surface of the first alignment layer 412 and second liquid crystal molecules 302 adjacent to a surface of the second alignment layer 421. In an initial state in which no electric field has been formed, the first liquid crystal molecules 301 and the second liquid crystal molecules 302 may be aligned substantially vertically by the vertical alignment groups of the polyimides contained in the first alignment layer 412 and the second alignment layer 421, respectively. In addition, at least part of the photocuring agent 20 contained in the first alignment layer 412 may flow into the liquid crystal layer 300 to be located near the first substrate 100.

In some embodiments, the manufacturing process may further include an annealing operation to improve the spread and uniformity of the liquid crystal molecules after the formation of the liquid crystal layer 300 and facilitate the outflow of the photocuring agent 20 in the first alignment layer 412.

Referring to FIGS. 12 through 16, light is irradiated in a state where an electric field has been applied to the liquid crystal layer 300 (operation S260). For example, when a vertical electric field is formed between the first substrate 100 and the second substrate 200, long axes of the liquid crystal molecules within the liquid crystal layer 300 may tilt in a direction perpendicular to the electric field. In addition, as the liquid crystal molecules tilt, the vertical alignment group of the polyimide in each of the first and second alignment layers 411 and 421 and the polymerization initiator in the first alignment layer 411 may tilt at an angle similar to that of the first and second liquid crystal molecules 301 and 302. The light may be UV light having a wavelength of approximately 300 to 380 nm or approximately 355 to 365 nm. In addition, the light may be irradiated at an exposure dose of approximately 0.1 to 15 J/cm² or approximately 1 to 4 J/cm². The photocuring agent 20 according to the present example embodiment may have a high absorption rate for light having the above wavelength. Thus, the photocurable layer 22 providing a pretilt angle may be formed with a relatively low exposure dose of, e.g., 4 J/cm² or less.

When light is irradiated to the liquid crystal layer 300 having the photocuring agent 20, a photopolymerization reaction may be induced by the polymerization initiator introduced to a side chain of the polyimide in the first alignment layer 412. As a result, the photocurable layer 22 at least partially including an azobenzene group may be formed on the first alignment layer 412. The photocurable layer 22 may be formed by polymerization of mono-molecules of the photocuring agent 20 or by the formation of a polymer compound, in which the mono-molecules of the photocuring agent 20 are chemically bonded to the vertical alignment group of the polyimide in the first alignment layer 412, in the form of fine protrusions to cover the surface of the first alignment layer 412. The photocuring agent 20 may be reactive mesogens, and the polymer compound may be polymers of the reactive mesogens.

A rigid group of a reactive mesogen may include an azobenzene group, for example, at its center portion, and a polymerizable end group of the reactive mesogen may include, for example, methacrylate, acrylate, vinyl, vinyloxy, epoxy, etc. For example, the polymerizable end group may be any one of

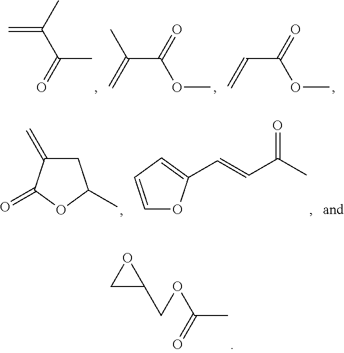

In addition, the reactive mesogen may have a bar structure, a banana structure, a board structure, or a disc structure.

In an example embodiment, the reactive mesogen may include a compound structured as in Chemical Formula (1) below:

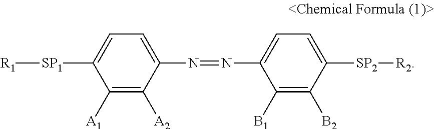

In Chemical Formula (1), each of R₁ and R₂ may independently be a methacrylate group, an acrylate group, a vinyl group, a vinyloxy group, or an epoxy group, each of SP₁ and SP₂ may independently be a single bond, an alkyl group having 1 to 12 carbon atoms, or an alkoxy group having 1 to 12 carbon atoms, each of A₁ and A₂ may independently be hydrogen or a halogen, and each of B₁ and B₂ may independently be hydrogen or a halogen. In an implementation, at least one of A₁ and A₂ may be hydrogen, and at least one of B₁ and B₂ may be hydrogen.

In an example embodiment, the reactive mesogen may include a compound structured as in any one of, for example, Chemical Formulae (2) through (5) below:

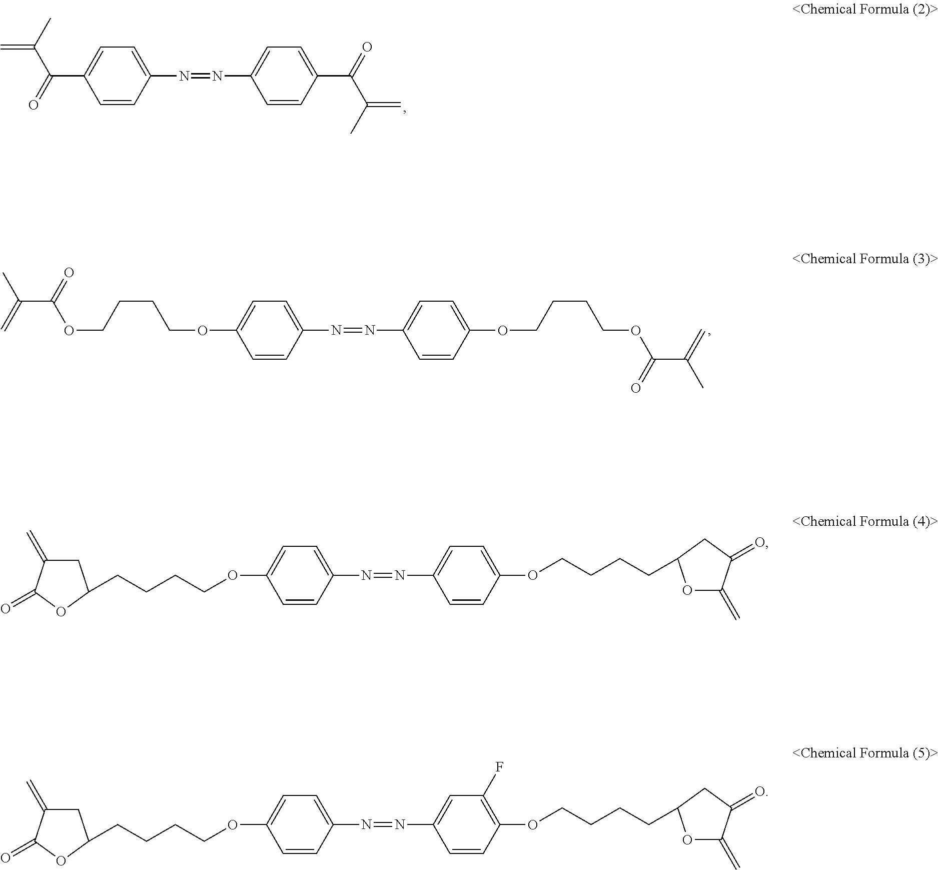 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

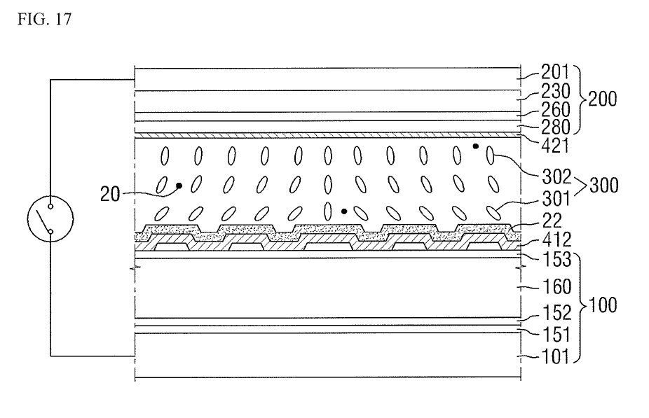

Referring to FIG. 17, the alignment direction of the first liquid crystal molecules 301 is fixed or stabilized by the tilted photocurable layer 22. Therefore, in a state where no electric field has been formed, the first liquid crystal molecules 301 remain at a pretilt angle, whereas the second liquid crystal molecules 302 are aligned substantially vertically. In this case, the first liquid crystal molecules 301 are aligned at approximately a first pretilt angle θ1, and the second liquid crystal molecules 302 are aligned at approximately a second pretilt angle θ2 greater than the first pretilt angle θ1. Thus, the second liquid crystal molecules 302 adjacent to the second substrate 200 may be aligned more vertically than the first liquid crystal molecules 301 adjacent to the first substrate 100. An average pretilt angle of the first liquid crystal molecules 301 and the second liquid crystal molecules 302 in the liquid crystal layer 300 may be approximately 88.8 degrees or less. However, an appropriate average pretilt angle can be selected by those of skill in the art. After the formation of the photocurable layer 22 on the surface of the first alignment layer 412, the surface roughness of the first alignment layer 412 may be greater than that of the second alignment layer 421.

Referring to FIGS. 12 through 18, light is irradiated again in a state where no electric field has been applied to the liquid crystal layer 300 (operation S270). The light may be UV light. The irradiating of the light to the liquid crystal layer 300 may remove the photocuring agent 20 remaining in the liquid crystal layer 300. The light may be irradiated for, for example, approximately 120 minutes or less or approximately 80 minutes or less. The photocuring agent 20 may include the azobenzene group as the rigid group. Thus, it may show a high absorption rate for a wavelength of light used in the re-irradiating of the light (operation S270). Therefore, with a short exposure time and a small exposure dose, most of the remaining photocuring agent 20 may be removed to such an extent not to generate afterimage. This may improve process efficiency and prevent a reduction in VHR by preventing the possible damage to liquid crystal molecules during light irradiation. In this case, the content of the photocuring agent 20 remaining in the liquid crystal layer 300 may be approximately 100 ppm or less.

In the re-irradiating of the light (operation S270), the second liquid crystal molecules 302 may still remain vertically aligned compared with the first liquid crystal molecules 301.

Next, both ends of the first substrate 100 and the second substrate 200 may be bent, and a backlight unit may be provided under the first substrate 100, thereby producing a curved LCD. The method of manufacturing an LCD according to the current embodiment may reduce manufacturing costs by using a liquid crystal composition without a photocuring agent and make it easy to maintain and manage the liquid crystal composition.

The following experiments are provided in order to highlight characteristics of one or more embodiments, but it will be understood that the experiments are not to be construed as limiting the scope of the embodiments.

<Reference 1>

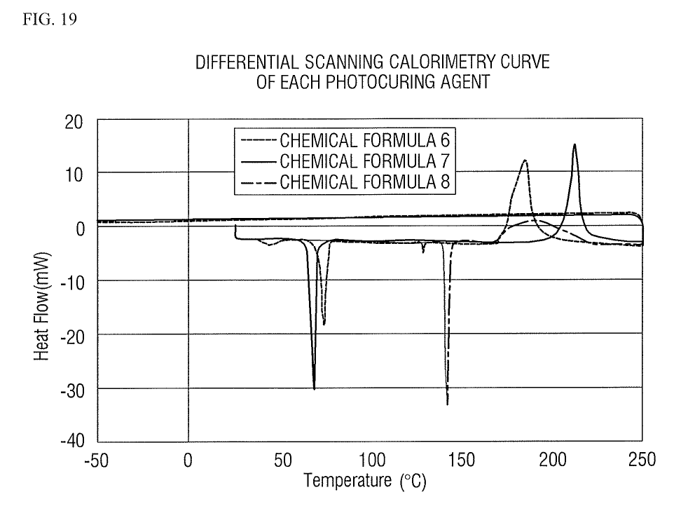

Thermophysical properties of compounds represented by Chemical Formulae (6) through (8) were measured using DSC, and the measurement results are illustrated in FIG. 19.

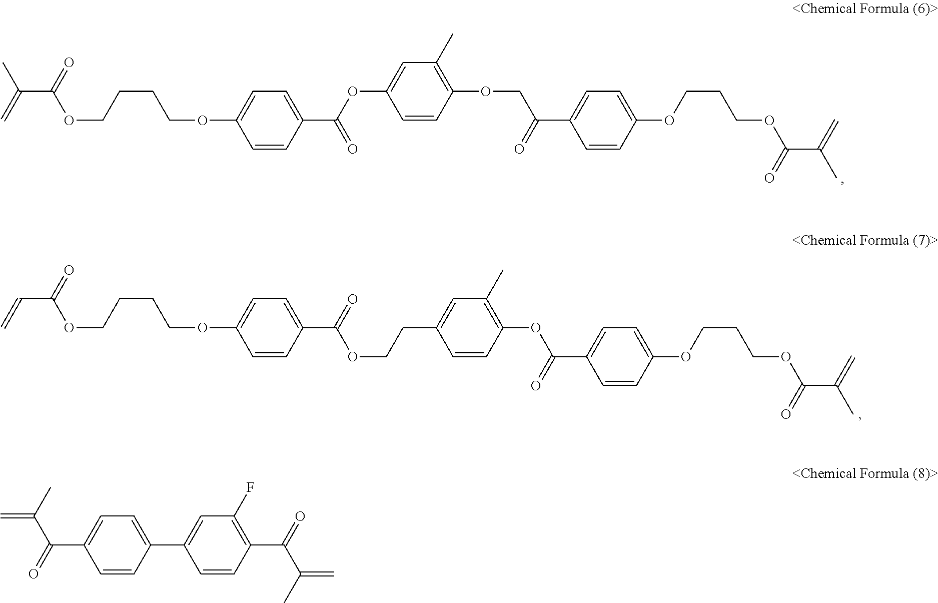

Referring to FIG. 19, a point, i.e., a phase transition temperature at which a maximum peak of a photocuring agent represented by Chemical Formula (6) starts is approximately 194.3° C., a phase transition temperature of a photocuring agent represented by Chemical Formula (7) is approximately 169.7° C., and a phase transition temperature of a photocuring agent represented by Chemical Formula (8) is approximately 167.7° C.

Without being bound by theory, it is believed that, the longer the rigid group in a photocuring agent (reactive mesogens) and the more the strong bonds included in the photocuring agent, the higher the phase transition temperature and the better the thermal stability.

<Reference 2>

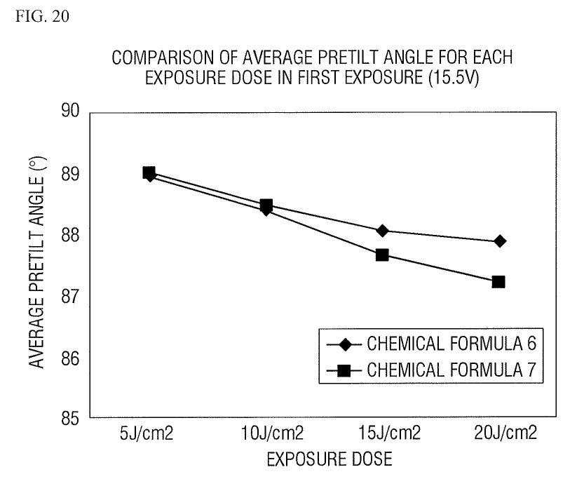

In a method of manufacturing an LCD, the photocuring agents represented by Chemical Formulae (6) and (7) were used. After a liquid crystal layer was interposed between a first substrate and a second substrate, UV light was irradiated (a first exposure process) to manufacture an LCD by varying an exposure dose in a state where an electric field of 15.5 V had been applied to the liquid crystal layer. Then, an average pretilt angle of liquid crystal molecules in the liquid crystal layer was measured, and the measurement results are illustrated in FIG. 20.

Referring to FIG. 20, in the state where an electric field of 15.5 V has been applied, the average pretilt angle of the liquid crystal molecules in the liquid crystal layer is reduced as the exposure dose increases. Thus, the alignment of the liquid crystal molecules becomes close to vertical alignment as the exposure dose increases. In addition, an exposure dose of at least 10 J/cm² or more gave an average pretilt angle of approximately 88.8 degrees or less.

Without being bound by theory, it is believed, from the results of Reference 1 and Reference 2, that an improvement in thermal stability of a photocuring agent results in a reduction in photoreactivity, and that thermal stability and photoreactivity have a trade-off relationship.

<Reference 3>

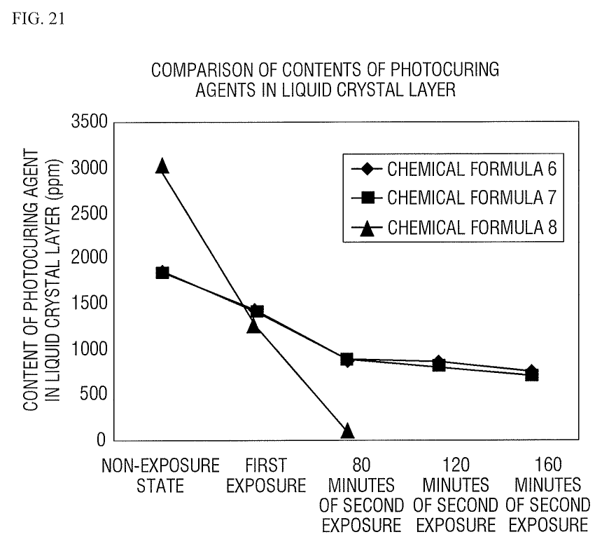

In a method of manufacturing an LCD, the photocuring agents represented by Chemical Formulae (6) through (8) were used. After a liquid crystal layer was interposed (a non-exposure state) between a first substrate and a second substrate, UV light was irradiated to the liquid crystal layer in a state where an electric field had been applied to the liquid crystal layer (a first exposure process). Then, in a state where no electric field had been applied to the liquid crystal layer, UV light was irradiated to the liquid crystal layer by varying an exposure time (a second exposure process), thereby manufacturing an LCD. The contents of the photocuring agents in the liquid crystal layer were measured in the non-exposure state, the first exposure process and in the second exposure process for each exposure time, and the measurement results are illustrated in FIG. 21.

Referring to FIG. 21, the contents of the photocuring agents in the liquid crystal layer decrease from the non-exposure state toward the first exposure process and then toward the second exposure process. In addition, as the exposure time increases in the second exposure process, the contents of the photocuring agents in the liquid crystal layer decrease.

For example, the content of the photocuring agent represented by Chemical Formula (6) in the liquid crystal layer was approximately 861 ppm after having been exposed for approximately 80 minutes in the second exposure process, approximately 847 ppm after having been exposed for approximately 120 minutes in the second exposure process, and approximately 742 ppm after having been exposed for approximately 160 minutes. The content of the photocuring agent represented by Chemical Formula (7) in the liquid crystal layer was approximately 880 ppm after having been exposed for approximately 80 minutes in the second exposure process, approximately 816 ppm after having been exposed for approximately 120 minutes in the second exposure process, and approximately 703 ppm after having been exposed for approximately 160 minutes. In addition, the content of the photocuring agent represented by Chemical Formula (8) in the liquid crystal layer was approximately 88 ppm after having been exposed for approximately 80 minutes in the second exposure process.

Thus, in the case of the photocuring agents (reactive mesogens) represented by Chemical Formulae (6) and (7) and having relatively long rigid groups, the contents of the photocuring agents in the liquid crystal layer did not decrease significantly despite an increase in the exposure time in the second exposure process. On the other hand, in the case of the photocuring agent represented by Chemical Formula (8) and having a relatively short rigid group, the content of the photocuring agent in the liquid crystal layer dropped to less than 100 ppm after having been exposed only for approximately 80 minutes in the second exposure process.

Without being bound by theory, it is believed, from the results of Reference 2 and Reference 3, that lower photoreactivity of a photocuring agent makes it more difficult to remove the photocuring agent remaining in the liquid crystal layer in the second exposure process.

By way of summation and review, to compensate for a difference in the user's viewpoint, LCDs may be curved concavely or convexly to form a curved surface. From the perspective of a viewer, curved LCDs may be classified into portrait-type LCDs whose vertical length is greater than their horizontal length and which are curved in a vertical direction and landscape-type LCDs whose vertical length is smaller than their horizontal length and which are curved in a horizontal direction.

In a curved LCD or a flexible LCD, a display panel is bent. Therefore, an upper substrate and a lower substrate may be misaligned with each other. As a result, dark portions in the form of vertical lines may be seen in a pixel area. The dark portions in the form of the vertical lines in the pixel area not only reduce luminance, but also make stains or a particular color more noticeable to a viewer. This may become worse as the curvature of the LCD increases.

As described above, embodiments may provide a liquid crystal display (LCD) having improved display quality.

Embodiments may also provide a method of manufacturing an LCD having improved display quality.

In an LCD according to an embodiment, liquid crystal molecules adjacent to an upper substrate may be aligned more vertically than liquid crystal molecules adjacent to a lower substrate. This may improve light transmittance and minimize generation of texture due to misalignment.

In a method of manufacturing an LCD according to an embodiment, a photocurable layer is formed to give a pretilt angle to liquid crystal molecules. A photocuring agent having high thermal resistance may be used in the process of forming the photocurable layer. Thus, a loss of the photocuring agent due to a thermal reaction may be minimized, and the photocurable layer may be formed efficiently.

Further, the photocuring agent used has superior photoreactivity as well as high thermal resistance. Therefore, process efficiency may be improved, and an afterimage defect or a reduction in VHR due to the photocuring agent remaining in a liquid crystal layer may be suppressed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A liquid crystal display (LCD), comprising:
a first substrate which has a first surface;
a first alignment layer which is disposed on the first surface of the first substrate and includes a polymerization initiator;
a photocurable layer which is formed on the first alignment layer and includes an azobenzene group;
a second substrate which has a first surface facing the first substrate and a second surface located opposite the first surface thereof;
a second alignment layer which is disposed on the first surface of the second substrate; and
a liquid crystal layer which is interposed between the photocurable layer and the second alignment layer.

2. The LCD as claimed in claim 1, wherein the liquid crystal layer includes first liquid crystal molecules adjacent to the photocurable layer and second liquid crystal molecules adjacent to the second alignment layer, wherein the first liquid crystal molecules are aligned more vertically than the second liquid crystal molecules in an initial alignment state.

3. The LCD as claimed in claim 1, wherein surface roughness of the first alignment layer is greater than that of the second alignment layer.

4. The LCD as claimed in claim 1, wherein the second alignment layer does not include a polymerization initiator.

5. The LCD as claimed in claim 1, wherein the photocurable layer is formed by polymerization of a photocuring agent which contains a compound represented by Chemical Formula (1): 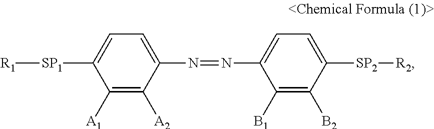
wherein, in Chemical Formula (1),
each of R₁ and R₂ is independently a methacrylate group, an acrylate group, a vinyl group, a vinyloxy group, or an epoxy group,
each of SP₁ and SP₂ is independently a single bond, an alkyl group having 1 to 12 carbon atoms, or an alkoxy group having 1 to 12 carbon atoms,
each of A₁ and A₂ is independently hydrogen or a halogen, provided that at least one of A₁ and A₂ is hydrogen, and
each of B₁ and B₂ is independently hydrogen or a halogen, provided that at least one of B₁ and B₂ is hydrogen.

6. The LCD as claimed in claim 5, wherein the compound represented by Chemical Formula (1) is a compound represented by any one of Chemical Formulae (2) through (5):

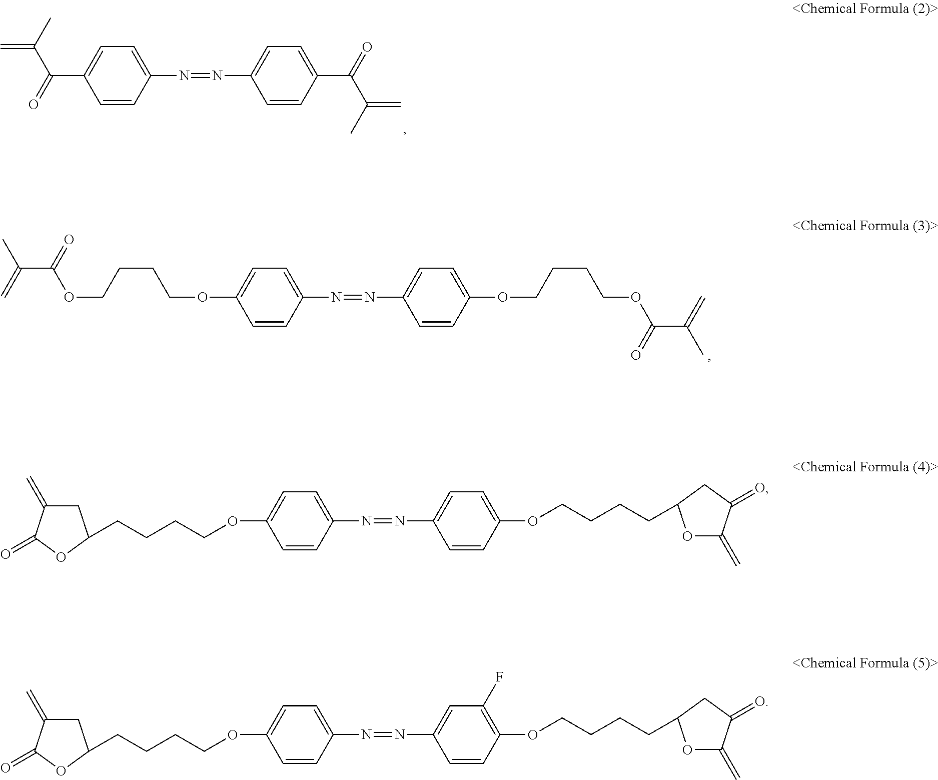 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

7. The LCD as claimed in claim 1, wherein the first substrate includes a first base substrate and a pixel electrode which is disposed on the first base substrate and has a domain partition means, and the second substrate includes a second base substrate and a common electrode which is disposed on the second base substrate.

8. The LCD as claimed in claim 1, wherein the first substrate and the second substrate are bent in the same direction, wherein the second surface of the second substrate is bent concavely.

9. A method of manufacturing an LCD, the method comprising:
preparing a first substrate having a first alignment layer, which includes a polymerization initiator, formed on a surface thereof;
preparing a second substrate having a second alignment layer formed on a surface thereof;
providing a liquid crystal layer between the first alignment layer and the second alignment layer; and
forming a photocurable layer, which includes an azobenzene group, on a surface of the first alignment layer by irradiating light in a state where an electric field has been applied to the liquid crystal layer.

10. The method as claimed in claim 9, wherein:
the preparing of the first substrate having the first alignment layer includes providing a first aligning agent, which includes a polymerization initiator, onto the first substrate and forming the first alignment layer by curing the first aligning agent,
the preparing of the second substrate having the second alignment layer includes providing a second aligning agent, which does not include a polymerization initiator, onto the second substrate and forming the second alignment layer by curing the second aligning agent, and
the providing of the liquid crystal layer includes providing a liquid crystal layer which includes a photocuring agent having an azobenzene group.

11. The method as claimed in claim 9, wherein:
the preparing of the first substrate having the first alignment layer includes providing a photocuring agent which includes an azobenzene group and a first aligning agent which includes a polymerization initiator onto the first substrate, and forming the first alignment layer by curing the first aligning agent, and
the preparing of the second substrate having the second alignment layer includes providing a second aligning agent, which does not include a polymerization initiator, onto the second substrate, and forming the second alignment layer by curing the second aligning agent.

12. The method as claimed in claim 11, wherein the curing of the first aligning agent includes curing the first aligning agent at a temperature of 170 to 250° C.

13. The method as claimed in claim 9, wherein ultraviolet (UV) light having a wavelength of 355 to 365 nanometers is irradiated in the irradiating of the light, and the photocurable layer is formed by polymerization of a photocuring agent having an azobenzene group.

14. The method as claimed in claim 13, wherein the photocuring agent includes a compound represented by Chemical Formula (1): 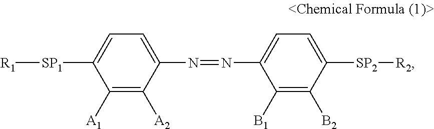
wherein, in Chemical Formula (1),
each of R₁ and R₂ is independently a methacrylate group, an acrylate group, a vinyl group, a vinyloxy group, or an epoxy group,
each of SP₁ and SP₂ is independently a single bond, an alkyl group having 1 to 12 carbon atoms, or an alkoxy group having 1 to 12 carbon atoms,
each of A₁ and A₂ is independently hydrogen or a halogen, provided that at least one of A₁ and A₂ is hydrogen, and
each of B₁ and B₂ is independently hydrogen or a halogen, provided that at least one of B₁ and B₂ is hydrogen.

15. The method as claimed in claim 14, wherein the compound represented by Chemical Formula (1) is a compound represented by any one of Chemical Formulae (2) through (5):

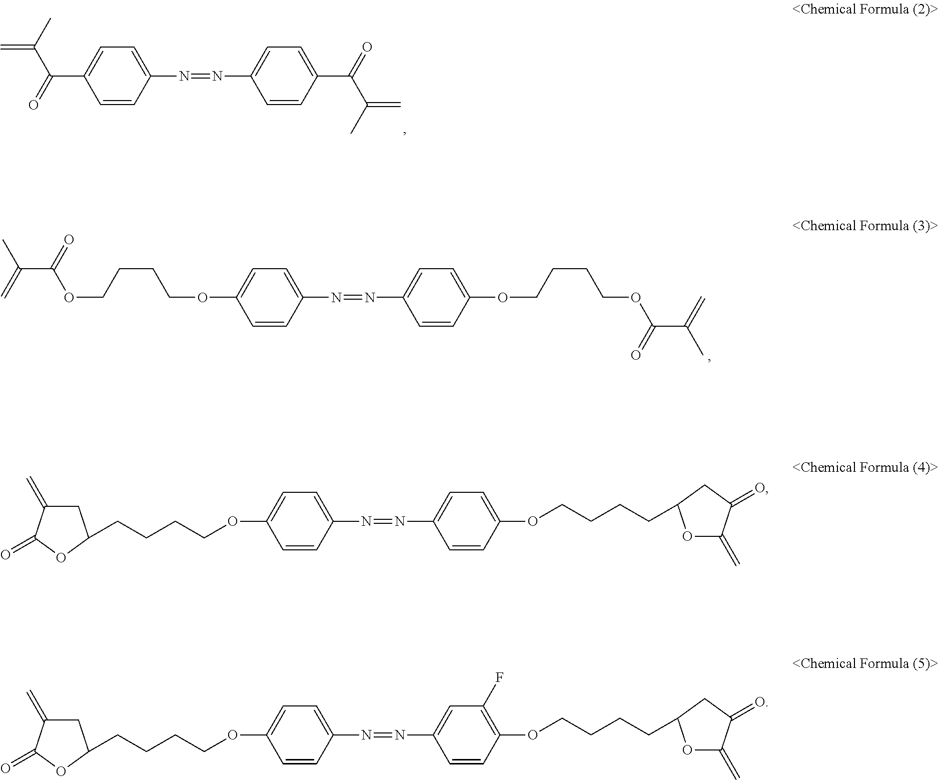 [SMILES: C=C(C)C(=O)c1ccc(N=Nc2ccc(C(=O)C(=C)C)cc2)cc1 ; C=C(C)C(=O)OCCCCOc1ccc(N=Nc2ccc(OCCCCOC(=O)C(=C)C)cc2)cc1 ; C=C1CC(CCCCOc2ccc(N=Nc3ccc(OCCCCC4CC(=O)C(=C)O4)cc3)cc2)OC1=O ; C=C1CC(CCCCOc2ccc(N=Nc3ccc(OCCCCC4CC(=O)C(=C)O4)c(F)c3)cc2)OC1=O]

16. The method as claimed in claim 13, further comprising irradiating light in a state where no electric field has been applied to the liquid crystal layer after the irradiating of the light in the state where the electric field has been applied to the liquid crystal layer.

17. The method as claimed in claim 16, wherein the liquid crystal layer includes first liquid crystal molecules adjacent to the photocurable layer and second liquid crystal molecules adjacent to the second alignment layer, and the second liquid crystal molecules are aligned more vertically than the first liquid crystal molecules in the irradiating of the light in the state where no electric field has been applied to the liquid crystal layer.

18. The method as claimed in claim 16, wherein, in the irradiating of the light in the state where no electric field has been applied to the liquid crystal layer, surface roughness of the first alignment layer is greater than that of the second alignment layer.

19. The method as claimed in claim 16, wherein the UV light having the wavelength of 355 to 365 nanometers is irradiated at an exposure dose of 4 J/cm² or less in the irradiating of the UV light having the wavelength of 355 to 365 nanometers, a phase transition temperature of the photocuring agent is 200° C. or above, and an average pretilt angle of liquid crystal molecules in the liquid crystal layer is 88.8 degrees or less in the irradiating of the light in the state where no electric field has been applied to the liquid crystal layer.

20. The method as claimed in claim 16, wherein the UV light is irradiated for 80 minutes or less in the state where no electric field has been applied to the liquid crystal layer in the irradiating of the light in the state where no electric field has been applied to the liquid crystal layer, and content of the photocuring agent in the liquid crystal layer is 100 parts per million or less in the irradiating of the light in the state where no electric field has been applied to the liquid crystal layer.
